(19) United States
(12) Patent Application Publication
(10) Pub. No.: US 2026/0317466 A1
(43) Pub. Date: Oct. 15, 2026

(54) POLYMERIZATION IN LIQUID CRYSTALS

(71) Applicant: Ohio State Innovation Foundation, Columbus, OH (US)

(72) Inventors: Xiaoguang WANG, Powell, OH (US); Robert DUPONT, Columbus, OH (US); Meng ZHANG, Columbus, OH (US)

(21) Appl. No.: 19/485,075

(22) PCT Filed: May 15, 2024
(86) PCT No.: PCT/US2024/029397

§ 371 Date: Nov. 17, 2025

Related U.S. Application Data
(60) Provisional application No. 63/466,487, filed on May 15, 2023.

(51) Int. Cl. C08F 220/14

(52) U.S. Cl. CPC C08F 220/14; C08F 2800/20; C08F 2810/20; C08F 2810/50

(57) ABSTRACT

Described herein is a shape memory polymer and method of making said polymer. The method provides a fabrication method of conformationally switching (i.e. from stretched to collapsed) polymers by use of liquid crystal (LC) solvents, which provide nanoconfined framework during polymerization. The LC solvent switches from a nematic to isotropic phase and imparts the phase ordering onto the polymer during polymerization. The LC solvent can be optionally removed, providing a system of conformationally switching polymer. The polymer reversibly changes conformation under external stimulus.

### CROSS-REFERENCE TO RELATED APPLICATIONS

This application claims priority to, and the benefit of, U.S. Provisional Application Ser. No. 63/466,487, filed May 15, 2023, the disclosure of which is expressly incorporated herein by reference in its entirety.

### BACKGROUND

The conformation of polymer chains, or how polymer chains are spatially arranged, is crucial to achieve desired physicochemical properties. The strategic alignment of polymer chains has been shown to enhance mechanical strength, elasticity, and ion/electron conductivity in polymeric materials. In addition, the opportunity for reversible conformational changes, such as transitioning from aligned to random coil conformations, is essential for the design of two-way shape memory polymers and is required for their use as artificial muscles and soft robotics. Current chain alignment approaches primarily focus on external fields or hard nanoconfinements, including mechanical stretching, flow-induced alignment, electric/magnetic fields, surface-induced alignment, and in-situ polymerization within nanopores, such as in anodic aluminum oxide. However, these methods mainly achieve chain alignment in polymers with intrinsic crystallinity (e.g., (semi) crystalline, liquid crystalline, and conjugated polymers), presenting a grand challenge for intrinsically amorphous polymers like polymethyl methacrylate (PMMA), polystyrene, and polybutyl acrylate, which lack necessary molecular motifs for self-alignment. Moreover, rapid and irreversible chain relaxation into a random coil upon heating blocks the creation of a two-way shape memory effect.

Shape memory polymers (SMPs) are able to change their shape in response to an external stimulus, such as a change in the temperature. Because of this characteristic behavior, they are often called stimuli-responsive polymers. Traditionally, these materials can only change their shape in one direction, usually between a temporary shape and a permanent, memorized shape, and are unable to return to the temporary shape. However, two-way shape memory responses have been shown in SMPs that allow the polymers to reversibly switch between the two shapes. As such, two-way SMPs have seen expanded application in soft actuators and soft robotics, which are lightweight, easily customizable, and fill areas where conventional rigid robots are not viable.

Past studies have demonstrated that the reversible shape changes of two-way SMPs are caused by switching between two polymer phases that depend on the microscopic packing of polymer molecules. Specifically, polymer molecules contain many repeating units (monomers) bonded together to make long chains; at high temperatures, chains maximize entropy by coiling randomly like a bowl of spaghetti but are able to stretch and align at lower temperatures.² The current design of two-way SMPs relies on polymers with intrinsic crystallinity, such that the chains neatly pack together like uncooked spaghetti. This packing usually requires specific molecular motifs found in semicrystalline polymers and liquid crystalline (LC) polymers.³⁻⁶ However, the monomers required for these polymers are either expensive (e.g., ~$90,220 per kilogram of LC monomer in FIG. 1, bottom left, from Synthon Chemicals GmbH & Co. KG, Germany) or require complicated synthesis procedures. Additionally, many of these polymers are toxic to humans or animals and are unsuitable for bio-related applications, such as implants that are designed to be installed in the body. On the other hand, common non-crystalline or amorphous polymers, such as polymethyl methacrylate (PMMA) and polystyrene, do not exhibit reversible shape changes in response to environmental cues, but are inexpensive (e.g., the global price of styrene in 2021 was ~$1.42 per kilogram), are widely used in daily life (e.g., polystyrene in disposable cups and food containers and PMMA in acrylic glass), and can be found in many biomedical applications (e.g., PMMA-based bone cement and implants). If amorphous polymers could be controllably stretched, aligned, and packed to allow for reversible shape changes, we could create low-cost, biocompatible or biodegradable soft actuators and soft robotics, enabling a novel higher-value recycling route (upcycling) for these common, less expensive polymers.

### SUMMARY

Described herein is a method to form and system of conformationally switching polymers. The method provides a fabrication method of conformationally switching (i.e. from stretched to collapsed) polymers by use of liquid crystal (LC) solvents, which provide nanoconfined framework during polymerization. The LC solvent switches from a nematic to isotropic phase and imparts the phase ordering onto the polymer during polymerization. The LC solvent can be optionally removed, providing a system of conformationally switching polymer. The polymer reversibly changes conformation under external stimulus such as heat.

The method, herein termed anisotropic solvent-aligned polymerization (ASAP), includes polymerizing amorphous monomers within a non-reactive nematic LC solvent, executed at low temperatures. The LC solvent acts as a soft nanoconfinement, significantly enhancing the alignment of amorphous polymers. Manipulating crosslinking density and polymer-solvent interactions during LC extraction kinetically traps polymer chains in an aligned configuration even after LC removal, thereby achieving reversible shape morphing in the resulting amorphous polymers. The ASAP method extends to various LC mesophases and amorphous monomers, expanding application of amorphous polymers in diverse fields such as soft actuators, optics, and polymer-stabilized LCs.

In some aspects, a conformationally switching polymer is disclosed, the polymer including: a monomer and crosslinker, wherein the monomer and crosslinker are component parts of a related non-crystalline polymer, and wherein the monomer and crosslinker are polymerized in a liquid crystal solvent.

In some aspects, the liquid crystal solvent is in a nematic phase.

In some aspects, polymerization is carried out at a temperature at which the liquid crystal solvent is in a nematic phase.

In some aspects, the monomer is chosen from vinyl, acrylate, methacrylate, epoxy, polyester, polyurethane, silicone, and nitrile based of monomers.

In some aspects, the monomer includes methyl methacrylate, styrene, n-butyl acrylate, t-butyl acrylate, methyl acrylate, or 2-ethylhexyl acrylate.

In some aspects, polymerization includes photopolymerization.

In some aspects, an external stimulus reversibly changes the polymer's conformation.

In some aspects, the external stimulus is a temperature change, wherein the temperature change is below a glass transition temperature of the polymer.

In some aspects, the polymer is contained in a vessel, and wherein the vessel includes one or more substrates.

In some aspects, the one or more substrates include a chemical coating.

In some aspects, the vessel includes two substrates having the same or different chemical coatings.

In some aspects, the chemical coatings are ordered to induce liquid crystal alignment.

In some aspects, the liquid crystal solvent is removed after the polymer is formed.

In some aspects, the polymer retains conformational switching after the liquid crystal solvent is removed.

In some aspects, a solvent is used to remove the liquid crystal solvent.

In some aspects, described herein is a method of forming a conformationally switching polymer, the method including: providing a liquid crystal solvent; providing a monomer and a crosslinker into the liquid crystal solvent, wherein the monomer and the crosslinker are non-crystalline; and polymerizing the monomer and the crosslinker in the liquid crystal solvent at a temperature at which the liquid crystal solvent is in a nematic phase.

In some aspects, the liquid crystal solvent, the monomer, and the crosslinker are provided to a reaction vessel with one or more substrates.

In some aspects, the one or more substrates have a same or different chemical coatings.

In some aspects, the method includes providing a photo-initiator before polymerizing.

In some aspects, the method includes providing a first external stimulus for polymerizing.

In some aspects, the first external stimulus is light radiation.

In some aspects, the method includes providing a second external stimulus to the polymer, wherein the second external stimulus changes the polymer's conformation, wherein the second external stimulus is a temperature change.

In some aspects, the temperature change is below a glass transition temperature of the polymer.

In some aspects, the method further includes removing the liquid crystal solvent, wherein the polymer retains conformational switching after the liquid crystal solvent is removed.

In some aspects, a solvent is used to remove the liquid crystal solvent.

### BRIEF DESCRIPTION OF DRAWINGS

FIG. 1 shows polymerization in LCs at different temperatures.

FIG. 2 shows molecular structures of the LC, E7, amorphous monomer, methyl methacrylate (MMA), and amorphous crosslinker, 1,6-hexanediol diacrylate (HDDA).

FIG. 3A-3C show schematic and corresponding polarized light micrographs showing PMMA polymerized in E7 at (FIG. 3A) 70° C., (FIG. 3B) 25° C., and (FIG. 3C) −70° C. The micrographs were captured at 25° C. The crossed arrows indicate the direction of the crossed polarizers. The double headed arrows indicate the LC alignment direction during polymerization. Scale bars, 200 μm.

FIG. 4 shows light transmission through E7-infused PMMA networks polymerized using different methods between crossed polarizers.

FIG. 5 shows conversion of MMA and HDDA with different polymerization methods as a function of polymerization time. All samples were made with 11% wt MMA and 1.5% wt HDDA in 87.5% wt E7.

FIG. 6 shows the effect of solvent type on polymer conformation after LC removal.

FIG. 7 shows light transmission through crosslinked PMMA network after LC removal using different solvents (red: good solvent; blue: poor solvent; black: theta solvent) between crossed polarizers. Insets show polarized light micrographs of crosslinked PMMA films after LC removal using ethanol. Scale bar, 200 μm.

FIG. 8 shows 2D WAXS pattern of crosslinked PMMA films after removing E7 with ethanol.

FIG. 9 shows average real part of dielectric function (¿′) of E7 and PMMA systems within frequency of 10³-10⁴ Hz at 25° C.

FIG. 10 shows DSC heat flow of crosslinked PMMA films after LC removal.

FIG. 11 illustrates polymer chain conformations and shape memory effects before and after high temperature treatment.

FIG. 12A-12C show temperature-dependent dimensions (relative to the LC director during polymerization) of crosslinked PMMA films, obtained with unidirectional LC ordering using ASAP after removing the E7 with ethanol (FIG. 12A), after 1,000 cycles (FIG. 12B), after keeping the PMMA film at 170° C. for two hours, where it no longer exhibited reversible shape changes (FIG. 12C).

FIG. 13. shows the relationship between chain conformations and shape deformability of polymer networks formed in non-reactive LCs at different polymerization temperatures (LC phases) and crosslinking densities. The non-reactive LC content during polymerization remains constant (87.5% wt) in this figure.

FIG. 14 shows complex shape deformations of HDDA-crosslinked PMMA films created by adjusting the alignment of the templating LC solvent during ASAP. Scale bars, 1 mm.

FIG. 15 shows the reversible dimensional changes and actuation temperature of the crosslinked polymer network through ASAP of various amorphous monomers after removing the E7 with ethanol. The LC adopted an in-plane unidirectional alignment during ASAP.

FIG. 16 shows applications of recyclable amorphous materials into soft actuators and soft robotics using the ASAP method.

FIG. 17 shows representative semicrystalline polymer and liquid crystal elastomer (LCE)-based two-way SMPs.

FIG. 18 shows synthesis of amorphous polymers.

FIGS. 19A-19B show a typical LC phase transition (FIG. 19A), and synthesis and reversible shape change of LCEs (FIG. 19B).

FIG. 20 shows an overview of the liquid crystal templating method. (A) Polymerization and crosslinking of non-crystalline monomers in an LC solvent to stretch the polymer chains. (B, top) Extracting the LC using proper solvent-polymer interactions results in a polymer film with stretched polymer chains (C, top) that enable reversible shape changes. (B, bottom) In contrast, the use of solvents that swell the polymer removes the alignment of the polymer chains (C, bottom) which hinders any potential shape changes.

FIG. 21 shows LC ordering between chemically functionalized glass substrates and the molecular structure of E7.

FIG. 22 shows the temperature-dependent shape deformation behaviors of the PMMA films after polymerization and extraction of E7. Scale bars, 5 mm.

FIG. 23A-23B show reversible bending of PMMA films polymerized in nematic E7 upon heating to 110-130° C. and cooling to 25° C.

FIG. 24 shows molecular structures of non-crystalline monomers and crosslinkers.

FIG. 25 shows the PMMA films polymerized in nematic E7 no longer exhibit reversible bending when the temperature is raised to 170° C.

FIG. 26 shows the reversible and irreversible polymer chain conformation and the consequent shape changes at different temperatures.

FIGS. 27A-27C show polarized light micrographs of polystyrene networks polymerized in E7 at (A) −60° C., (B) 70° C., and (C) 25° C. before the removal of E7. The double-headed arrows indicate the polyimide rubbing direction. The crossed double-headed arrows indicate the orientation of the crossed polarizers.

FIG. 28 shows the effect of crosslinking density on the polymer network formed in nematic LCs (Method 3).

FIG. 29 shows the effect of solvent-polymer interactions during the LC removal process on polymer chain conformation after solvent evaporation.

FIGS. 30A-30B show dimension (with respect to rubbing direction) of polystyrene films obtained in nematic E7 (Method 3) as a function of temperature. Heating/cooling rate was 10° C./min.

FIG. 31 shows photographs of the shape deformation of polystyrene films (Method 1) upon heating.

FIG. 32 shows preservation of chain conformations of polymer networks at high crosslinking densities.

FIG. 33 shows LC ordering in chiral nematic phase.

FIG. 34 shows comparison of solvents for removal of LC solvent.

### DETAILED SPECIFICATION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The expressions “ambient temperature” and “room temperature” as used herein are understood in the art and refer generally to a temperature from about 20° C. to about 35° C.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell” refers to a reference composition, article, or an electrochemical cell comprising substantially identical components and wherein an inventive component is substituted with a common in the art component.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention nor the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

While aspects can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

The present invention may be understood more readily by reference to the following detailed description of various aspects of the invention and the examples included therein and to the Figures and their previous and following description.

In some aspects, the disclosed method and system related to polymerizing non-liquid crystal (LC) monomers in an LC solvent thereby confining the polymer chain conformations, as shown in FIG. 1. The resulting polymer is a conformationally switching polymer under defined conditions.

In one embodiment, a conformationally switching (e.g. reversible) polymer, herein the polymer, comprising a monomer and crosslinker is formed in a liquid crystal solvent. The monomer and crosslinker are component parts of a related non-crystalline polymer. In one example, the monomer is related to an amorphous, non-liquid crystal polymer, the monomer being chosen from vinyl, acrylate, methacrylate, epoxy, polyester, polyurethane, silicone, and nitrile based of monomers. For example, the monomer may include methyl methacrylate, styrene, n-butyl acrylate, t-butyl acrylate, methyl acrylate, or 2-ethylhexyl acrylate, and other non-crystalline monomers. The crosslinker is a non-crystalline molecule, such as HDDA, BDDA, or DVB.

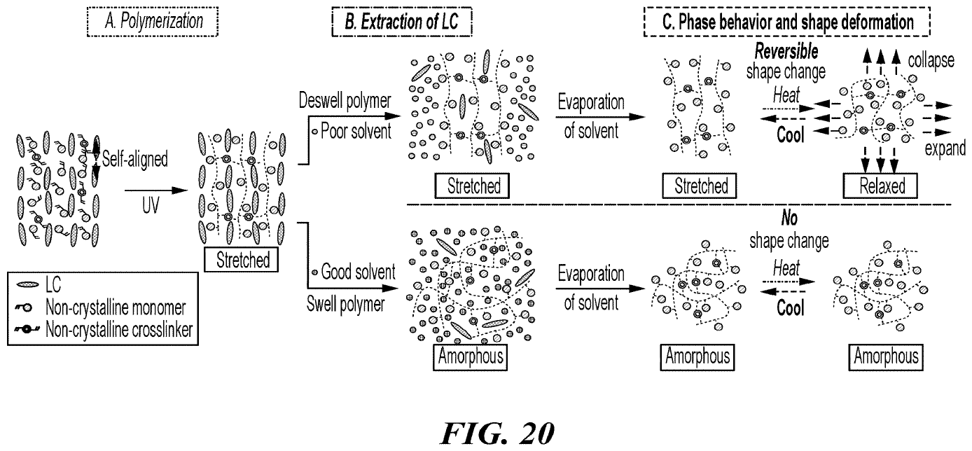

The switching polymer can reversibly switch between two conformations-namely stretched (e.g. low entropy state) and coiled (e.g. folded, high entropy state). The polymer is formed in a liquid crystal solvent that is in an ordered phase (e.g. nematic, chiral nematic) at the polymerization conditions (e.g. temperature, external stimulus, vessel structure). The liquid crystal solvent is chosen such that its ordered phase (e.g. nematic, chiral nematic) is stable at a wide range of temperatures (e.g. −70° C. to 60° C.). Using a liquid crystal solvent during polymerization provides a scaffold for the polymer to form in a stretched (e.g. low entropy) state (FIG. 20A).

Polymerization is carried out at a temperature at which the liquid crystal solvent is in a nematic phase (e.g. below −20° C. for nematic phase of E7). It is contemplated that other polymerization conditions (e.g. temperature, external stimulus, vessel structure) are also chosen to support the nematic or chiral nematic phase. In some aspects, the system further includes a photoinitiator that acts in photopolymerization. For example, the photoinitiator is 2,2-Dimethoxy-2-phenylacetophenone (DMPAP) or any other suitable photoinitiator.

In some embodiments, the monomer is an amorphous, non-liquid crystal monomer chosen from vinyl, acrylate, methacrylate, epoxy, polyester, polyurethane, silicone, and nitrile based of monomers. For example, the monomer may include methyl methacrylate, styrene, n-butyl acrylate, t-butyl acrylate, methyl acrylate, or 2-ethylhexyl acrylate, and other non-crystalline monomers. The crosslinker is a non-crystalline molecule, such as HDDA, BDDA, or DVB.

In some embodiments, the polymer is contained in a vessel, wherein the vessel includes one or more substrates. The one or more substrates include a chemical coating, the chemical coatings being ordered to induce liquid crystal alignment. Alternatively, or in addition, the vessel includes two substrates having the same or different chemical coatings.

In some embodiments, an external stimulus is applied to reversibly change the polymer's conformation. The external stimulus may be a temperature change, wherein the temperature change is below a glass transition temperature of the polymer. For example, a polymer having a glass transition temperatures of about 100° C. could be heated below 100° C. and a polymer having a glass transition temperature of about 50 could be heated below 50 without losing the conformational switching capabilities. It is contemplated that density of crosslinker, composition of the LC solvent, addition of photo initiator, vessel substrate, and other compositional and environmental variations may affect the glass transition temperature.

After polymerization, the liquid crystal solvent may be removed (FIG. 20B) using an extraction solvent. The extraction solvent is chosen based on the polymer so that the polymer does not swell (FIG. 20B). Extraction solvents that cause the polymer to swell result in irreversible amorphization of the polymer. After the liquid crystal solvent is removed and the extraction solvent is evaporated, the conformationally switching polymer is able to reversible change shape (e.g. conformational switching, stretched to relaxed) per FIG. 20C, top panel. In some examples, the solvent is chosen from methanol, ethanol, acetone, and combinations thereof. In one example, the solvent is ethanol when the LC solvent is E7.

In an exemplary embodiment, a method of forming a conformationally switching polymer is disclosed. The method including providing a liquid crystal solvent; providing a monomer and a crosslinker into the liquid crystal solvent, wherein the monomer and the crosslinker are non-crystalline; and polymerizing the monomer and the crosslinker in the liquid crystal solvent at a temperature at which the liquid crystal solvent is in a nematic phase. The monomer is chosen from methyl methacrylate, styrene, n-butyl acrylate, t-butyl acrylate, methyl acrylate, and 2-ethylhexyl acrylate. For example, the liquid crystal solvent is in a nematic phase over a range of temperatures from −70° C. to 60° C.

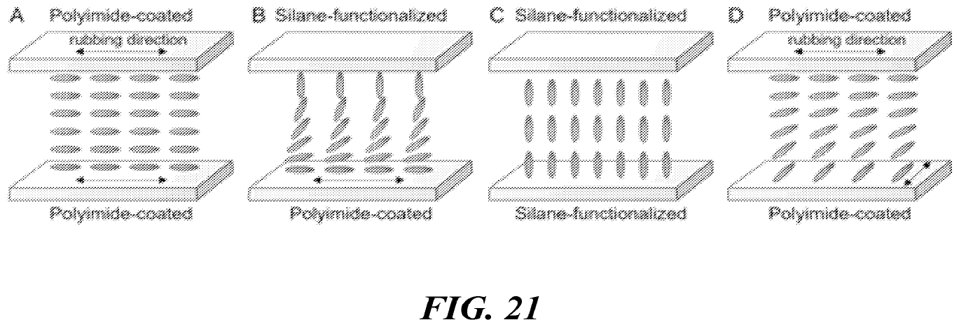

In some embodiments, the liquid crystal solvent, the monomer, and the crosslinker are provided into a reaction vessel with one or more substrates, wherein the one or more substrates have a same or different chemical coatings. For example, one or both sides are coated in silane and/or one or both sides are coated in polymide, as shown in FIG. 21.

In some embodiments, the method further includes providing a photo-initiator before polymerizing. Further still, the method includes providing a first external stimulus for polymerizing, wherein the first external stimulus is light radiation (e.g. UV, visible, or IR).

In some embodiments, the method further includes providing a second external stimulus to the polymer, wherein the second external stimulus changes the polymer's conformation. In some examples, the second external stimulus is a temperature change, wherein the temperature change is below a glass transition temperature of the polymer. In other examples, the second stimulus is an applied voltage. For example, a voltage is applied to a switching polymer formed in a chiral nematic E7 solvent, resulting in the conformational switching of the polymer.

In some aspects, the method further includes removing the liquid crystal solvent, wherein the polymer retains conformational switching after the liquid crystal solvent is removed. In some examples, a solvent is used to remove the liquid crystal solvent.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Example 1: Anisotropic Solvent-Aligned Polymerization. In 1969, Pierre-Gilles de Gennes foresaw that the polymerization and crosslinking of intrinsically amorphous polymers in a non-reactive, nematic liquid crystal (LC) solvent could imprint the LC ordering into the polymer network (1st prediction) (P. De Gennes, “Possibilities offertes par la reticulation de polymeres en presence d'un cristal liquid” (1969)). Despite this insightful prediction, previous attempts to polymerize amorphous monomers in non-reactive LC solvents at intermediate and high temperatures have proven insufficient in achieving this critical alignment of polymer chains. As shown in FIG. 1, high polymerization temperatures cause the LC solvent to remain in the isotropic phase throughout the entire polymerization process, forming LC organogels, while intermediate temperatures cause LCs to initially exist in the isotropic phase and then transition into the nematic phase through polymerization-induced phase separation, leading to polymer-dispersed LCs (PDLCs). Even when the polymer chains are predicted to successfully aligned by a nematic LC, the removal of the LC solvent allows the polymers to relax without major obstacle towards the random coil conformation, just as de Gennes further predicted (2nd prediction). Both predictions, and the benefits that 1st prediction offers, remain unrealized.

To experimentally address both predictions, the anisotropic solvent-aligned polymerization (ASAP) method was developed involving the synthesis and alignment of polymer chains by polymerizing and crosslinking amorphous monomers in a non-reactive LC solvent at low temperatures. Distinct from the creation of LC gels and PDLCs, low-temperature polymerization maintains the LC nematic phase throughout the entire process, acting as a soft nanoconfinement and enhancing the alignment of the intrinsically amorphous polymers. More importantly, by manipulating the crosslinking density and extracting the LC using a solvent with appropriate solvent-polymer interaction, the method kinetically traps the polymer chains in the aligned configuration from the polymerization process in nematic LCs. The metastability of this aligned conformation endows the crosslinked amorphous polymers with a remarkable two-way memory effect, facilitating reversible shape deformations. Finally, the ASAP method extends to various LC mesophases and amorphous monomers, broadening the application of amorphous polymers in soft actuators and robotics, optics, and polymer-stabilized LCs.

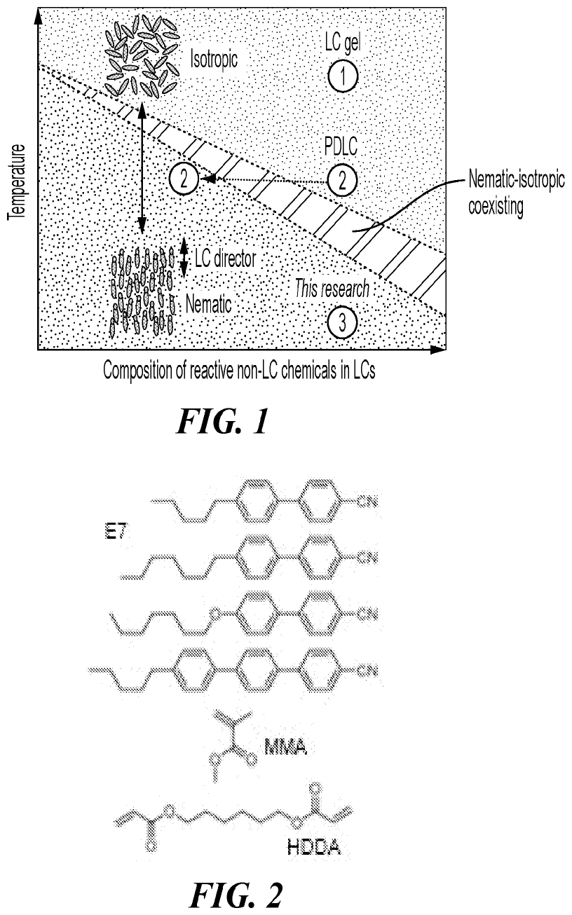

To test de Gennes' 1st prediction, the impact of LC mesophase on polymer chain conformations was investigated by polymerizing an amorphous monomer and an amorphous crosslinker in a non-reactive, nematic LC solvent, E7 (shown in FIG. 2), at different temperatures. This work used E7 because pure E7 exhibits a nematic phase over a wide temperature range (from −62° C. to 60° C.). Methyl methacrylate (MMA) was the model amorphous monomer, and hexanediol diacrylate (HDDA) and 2,2-dimethoxy-2-phenylacetophenone (DMPAP) served as the crosslinker and photoinitiator, respectively (FIG. 2). Photopolymerization was carried out by UV radiation at 365 nm, with a reaction vessel constructed from Elvamide®-coated glass slides promoting a parallel ordering of E7.

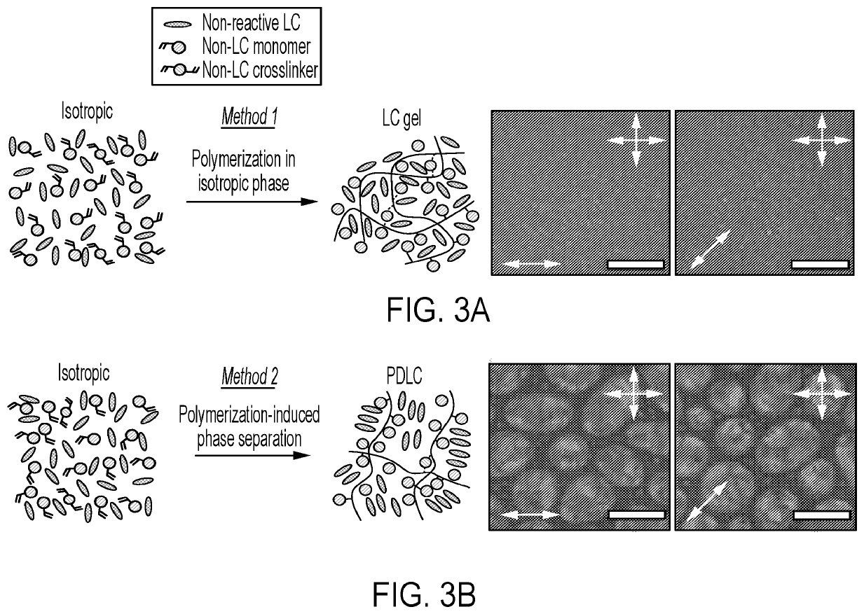

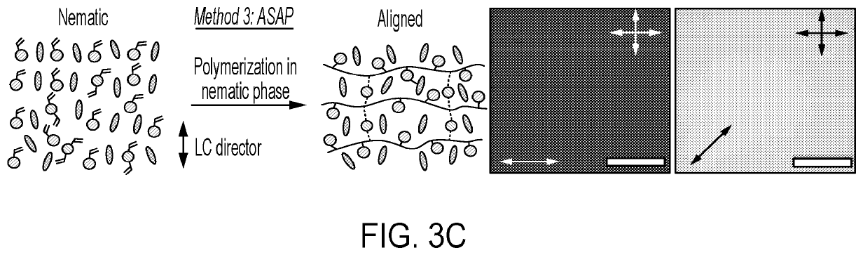

When the polymerization was conducted in isotropic E7 at 70° C., which is above the nematic-isotropic phase transition temperature (T_{N-I}) of pure E7, the E7-infused PMMA film exhibited a dark appearance under a polarized light microscope at the elevated temperature. Upon cooling to room temperature, the uniformly dispersed E7 transitioned to the nematic phase, revealing the well-dispersed E7 in the film without macroscopic phase separation (FIG. 3A), a characteristic of LC gels. On the other hand, when polymerization was carried out at an intermediate temperature (25° C.), a polymerization-induced phase separation process occurred, resulting in a polydomain morphology in the E7-infused PMMA films at all angles of rotation (FIG. 3B), a characteristic of PDLCs.

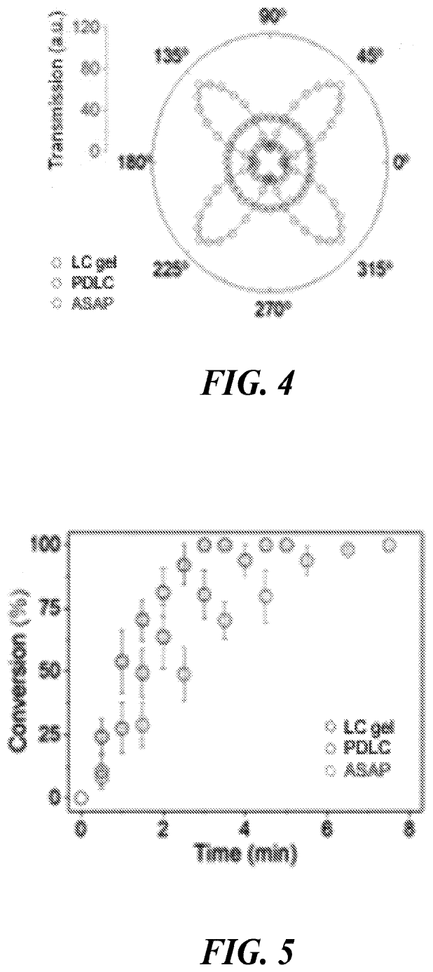

It is well established that the presence of non-LC species can reduce the T_{N-I} of LCs and induce the coexistence of the isotropic and nematic phases. For example, the transition temperature between the coexisting isotropic/nematic phase and the uniform nematic phase of a mixture comprising MMA (11% wt), HDDA (1.5% wt), and E7 (87.5% wt) was determined to be around −20° C. using polarized light microscopy and DSC. To ensure that the mixture remained in the nematic phase throughout the polymerization process, the polymerization temperature was set at −40° C. In contrast to traditional LC gels or PDLCs, low-temperature polymerized systems exhibited a uniform bright-dark optical transition without phase separation when rotated under crossed polarizers, as shown in FIGS. 3C and 4. This observation confirms that the presence of nematically ordered LCs during the polymerization of amorphous monomers generates sufficient nanoconfinement to achieve highly aligned conformations. This provides the first experimental realization of de Gennes' 1st prediction, which provides for shape-memory polymers of otherwise amorphous polymers, and which required low temperature conditions. It is noted that all three polymerization methods can achieve full conversion within seven minutes (FIG. 5).

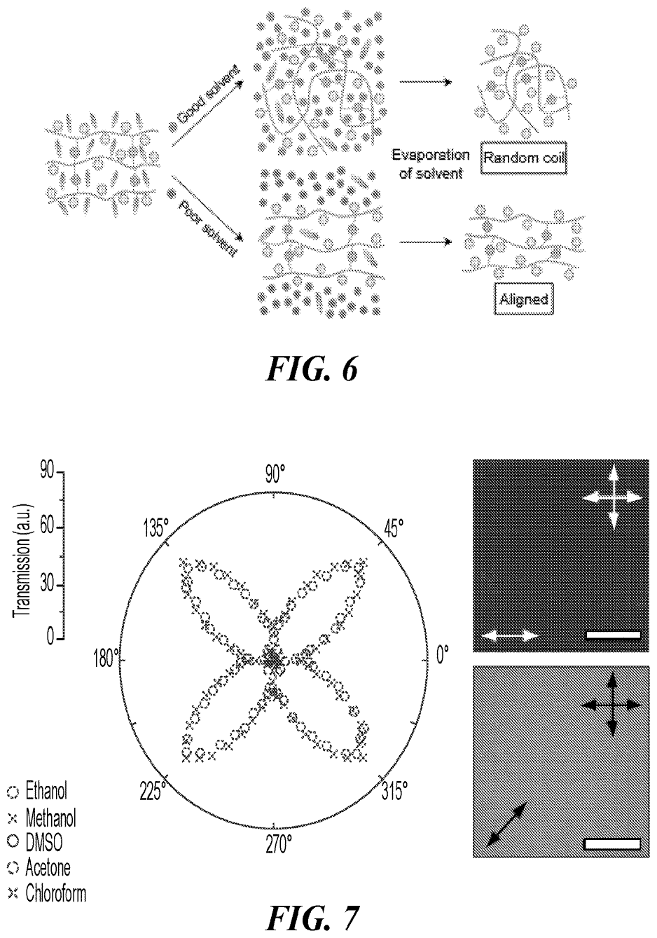

To provide insight into de Gennes' 2^{nd} prediction, an organic solvent was used to extract E7 and analyze the chain conformation of the purely crosslinked PMMA network following the evaporation of the extraction solvent, as illustrated in FIG. 6. When using a good solvent for PMMA, characterized by fully solvating the interior of the polymer and causing swelling of the material such as acetone, the resulting crosslinked PMMA film exhibited a uniform dark appearance under a polarized light microscope (FIG. 7), and the 2D wide-angle X-ray scattering (WAXS) pattern displayed an isotropic ring. These results suggest a random coil conformation after LC removal, thus confirming de Gennes' 2nd prediction. Similar disordered chain alignment was observed in the PMMA films obtained using Methods 1 and 2 (LC gel and PDLC) as shown in FIGS. 3A and 3B after the extraction of E7.

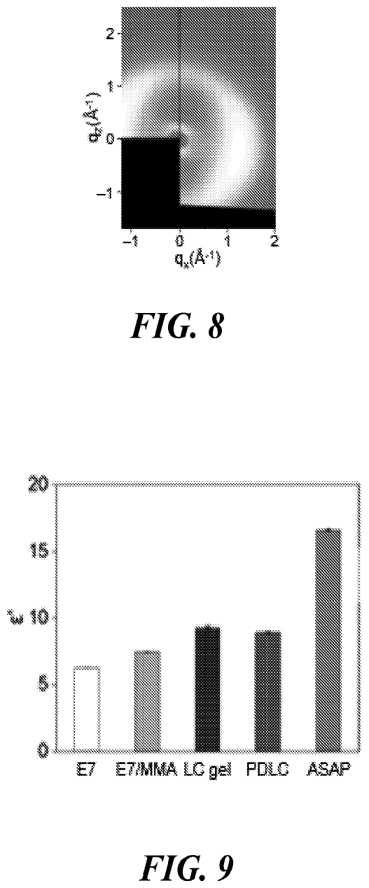

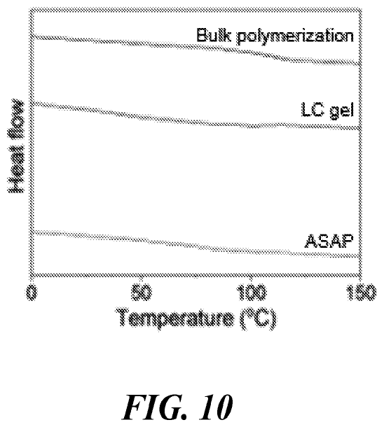

However, surprisingly, when a poor solvent for PMMA, characterized by poorly solvating the interior of the of the polymer such as ethanol, was used to extract E7, the PMMA network retained its birefringence (FIG. 2B), also evidenced by anisotropic patterns in the 2D WAXS pattern (FIG. 8). Additionally, the alignment of polymer chains significantly enhances the real part of the dielectric function of the LC-infused polymer network within the frequency of 10³-10⁴ Hz, as depicted in FIG. 9. Differential scanning calorimetry analysis in FIG. 10 reveals that PMMA films formed by all three methods exhibit a single phase transition, which is broadened and shifted to a lower temperature range compared to bulk polymerization. These findings suggest that the crosslinked polymer chains undergo alignment templated by E7 during the polymerization process, and remarkably, this alignment persists even after the removal of E7, contradicting de Gennes' 2^{nd} prediction.

The cause of this ‘contradiction’ is attributed to the solvent-polymer interactions during the LC removal process. When using poor solvents for LC removal, the preferred polymer-polymer self-interactions do not provide necessary free volume needed for the polymer chains to relax towards a random coil conformation, which is the most thermodynamically stable conformation for intrinsically amorphous polymers. Consequently, the aligned polymer chains experience shrinkage during LC removal, resulting in the kinetic trapping of the aligned conformation even after the removal of the LCs. When a good solvent is used for LC removal, the favored solvent-polymer interactions induce substantial swelling, enabling the reorganization of polymer chains into random coil conformations, in alignment with de Gennes' second prediction.

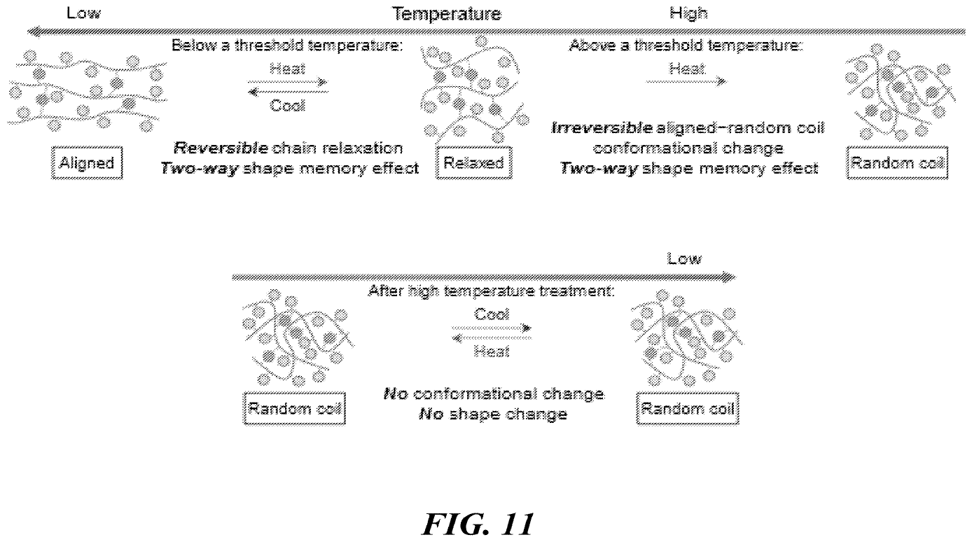

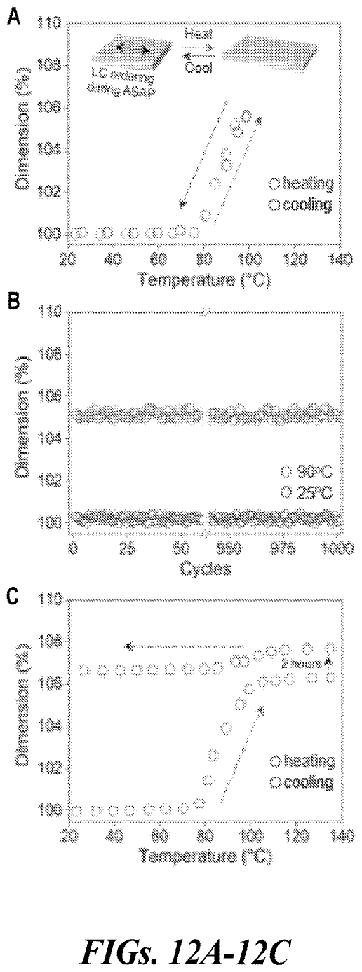

Considering that the equilibrium state of the intrinsically amorphous polymers is a random coil, the shape memory effect was manipulated by leveraging the metastability of the kinetically trapped aligned chain conformation. The aligned polymer chains can undergo reversible relaxation and alignment in response to temperature variations, below a threshold temperature such as the inherent glass transition temperature of the crosslinked PMMA film, resulting in a two-way shape memory effect similar to LCEs, as illustrated in FIG. 11. As demonstrated in FIG. 12A, after applying the ASAP method and removing E7 using ethanol, the resulting crosslinked PMMA films exhibit reversible unidirectional elongation in the direction of the E7 orientation during polymerization, with an onset actuation temperature of approximately 80° C. This shape deformation is repeatable for at least 1,000 cycles (FIG. 12B). However, prolonged exposure of the PMMA films above the glass transition temperature results in an irreversible chain conformational change, wherein the aligned polymer chains irreversibly reorganize towards the random coil conformation. As a result, the polymer networks undergo irreversible shape deformation and are unable to recover to their original shape even after cooling, resulting in a one-way shape memory behavior, as demonstrated in FIG. 12C.

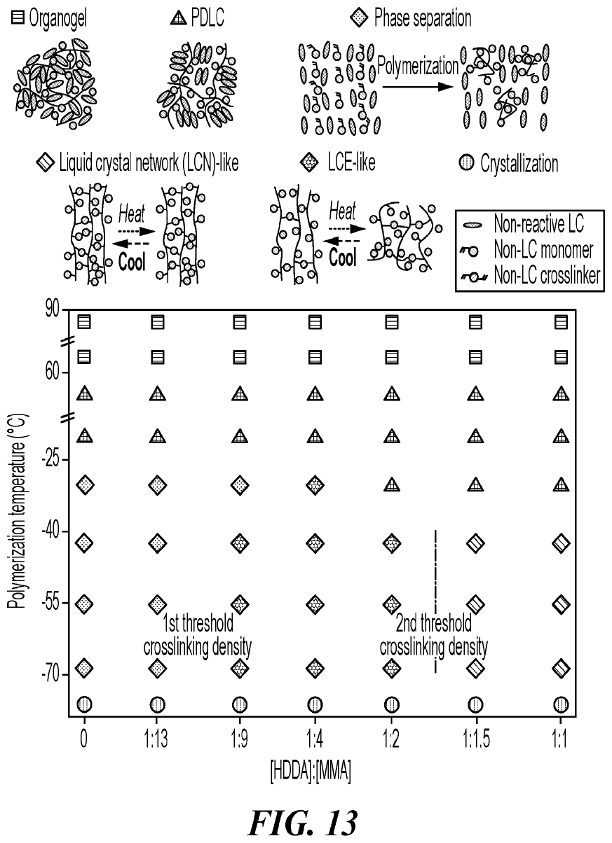

In addition to the polymerization temperature, the stability of aligned chain conformation in polymer networks synthesized in LCs was also influenced by the crosslinking density, as illustrated in FIG. 13. A lower threshold of crosslinking density was necessary to retain the chain alignment imprinted by the nematic LCs while applying the ASAP method, given the intrinsic lack of crystallinity in amorphous polymers. Insufficient crosslinking densities cause the polymer chains to lose their aligned conformations, reverting to random coils and separating from the bulk LC. Additionally, a second, higher threshold of crosslinking density exists. Beyond this threshold, aligned polymer chain conformations can be maintained after LC removal, but limited free volume may impede reconfiguration upon heating. This highly crosslinked polymer network demonstrates high thermal stability, restricting significant conformational changes and macroscopic shape deformation, similar to the characteristics of liquid crystal networks (LCNs).

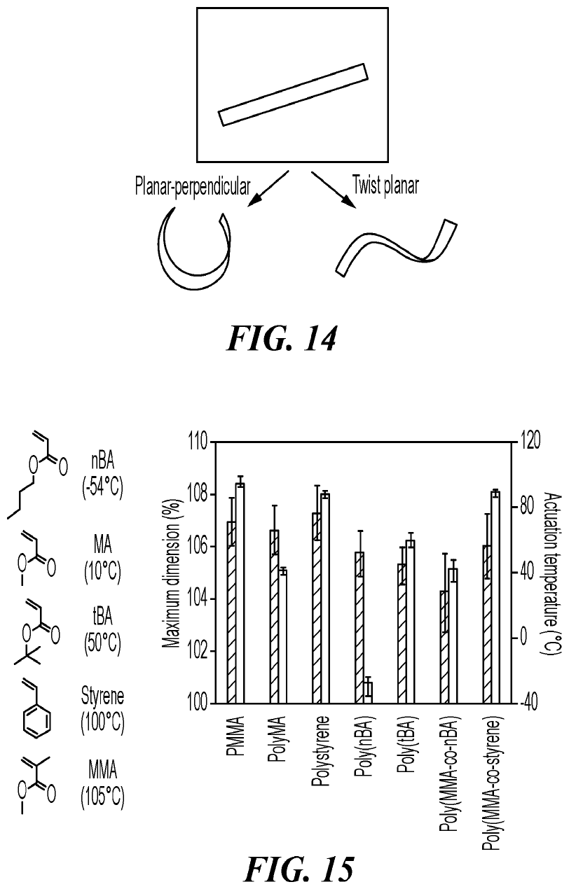

Furthermore, the generalizability of the ASAP method was demonstrated using a variety of LC orientations during polymerization and different amorphous monomers. By manipulating the orientation of the templating LC matrix in the ASAP method, the resulting crosslinked PMMA films exhibited intricate shape deformations, reminiscent of traditional LCEs. As shown in FIG. 14, a hybrid perpendicular-planar LC orientation induced bending locomotion, while a 90° twist planar ordering resulted in a helical twist. Beyond MMA, the ASAP method provides for effectively aligned polymer networks using a wide range of amorphous monomers, including styrene, methyl acrylate, n-butyl acrylate and t-butyl acrylate, as evident in FIG. 15. It is noted that the crosslinked polymer networks formed by different monomers exhibited distinct actuation temperatures, indicating varying intrinsic chain rigidity and their ability of the polymers to relax towards random coil conformations.

In the final set of experiments, complex polymer chain orientations were demonstrated by manipulating LC orientation during the application of the ASAP method. Beyond the previously discussed uniform surface alignment, the scanning polarization photoalignment method was employed to create surfaces with patterned LC alignments. The ASAP method enabled the creation of a PMMA network with precisely patterned chain alignments, templated by the LC orientation during polymerization, accurately replicating the grayscale image of a de Gennes picture. Furthermore, the versatility of the ASAP method was demonstrated across various LC phases beyond the nematic phases. Specifically, when the ASAP method was performed with the LC in the cholesteric phase, also known as chiral nematic, where LC molecules adopt a helical twist perpendicular to the LC director, the resulting chiral LC-infused PMMA network exhibit outstanding reflective properties. This remarkable stabilization of chiral LCs by amorphous polymer networks enables a switching effect upon the application of a direct current electric field.

Methods and Materials. LC E7, a mixture comprising 4-(4-heptylphenyl)benzonitrile (7CB), 4-(4-octoxyphenyl)benzonitrile (80CB), 4-(4-pentylphenyl)benzonitrile (5CB), and 4-[4-(4-pentylphenyl)phenyl]benzonitrile (5CT), was procured from Synthon Chemicals Ltd. Additionally, the following chemicals were obtained from Sigma-Aldrich: 2,2-dimethoxy-2-phenylacetophenone (DMPAP), dimethyloctadecyl[3-(trimethoxysilyl) propyl]ammonium chloride (DMOAP), poly(pyromellitic dianhydride-co-4,4′-oxydianiline) amic acid, 1-methyl-2-pyrrolidinone, elvamide pellets, methyl methacrylate (MMA), styrene, methyl acrylate (MA), tert-butyl acrylate (tBA), butyl acrylate (nBA), 1,6-hexanediol diacrylate (HDDA), (R)-1-phenyl-1,2-ethanediyl bis[4-(trans-4-pentylcyclohexyl)benzoate] (R1011), (R)-2-octyl 4-[4-(hexyloxy)benzoyloxy]benzoate (R811), acetone, chloroform, methanol, dimethyl sulfoxide, and ethanol. Plain microscope glass slides and indium-tin oxide (ITO)-coated glass slides were sourced from Fisher Scientific. Unless otherwise specified, all commercial chemicals and materials were used as received without further modification or purification.

Fabrication of optical cells for polymerization in LCs. Plain microscope glass slides were washed three times with water and ethanol. For planar LC ordering, the glass slides were spin-coated with an Elvamide® methanol solution (0.125 g of Elvamide® in 100 mL of methanol) at 2,000 rpm for 20 seconds. Next, the Elvamide®-coated glass slides were rubbed with a velvet cloth 60 times to create an in-plane parallel alignment for LCs. To achieve perpendicular LC orientation, the glass slides were placed in a 1% v/v DMOAP water solution for 15 minutes. Subsequently, the glass slides were washed with water and ethanol and dried using nitrogen gas. Finally, two of the chemically functionalized glass slides were paired, with spacers placed between the ends of the glass slides. An offset was left at the side of the glass slides to facilitate LC filling through capillary forces.

Polymerization in LCs at different temperatures. For polymerization in LCs, a mixture comprising LC E7, amorphous monomer, and crosslinker HDDA was prepared. The composition of the three components were varied in experiments, for instance, a typical MMA-based LCE-like film might consist of 87.5 wt % E7, 10 wt % MMA, and 2.5 wt % HDDA. The photoinitiator, DMPAP, was added at 2 wt % relative to the total weight of the reactive monomers. The mixture was then introduced into an optical cell via capillary forces and allowed to rest at room temperature (25° C.) for 10 minutes. During this period, the LCs were in the isotropic phase due to the addition of non-LC components, as indicated by their transparent appearance.

For polymerization at elevated temperatures to produce LC gels, the filled optical cells were placed on a hot plate and heated to 75° C. for 10 minutes before polymerization. For polymerization at intermediate temperatures to create PDLCs, the filled optical cells were left at room temperature for 10 minutes before polymerization. For ASAP at low temperatures, the filled optical cells are placed on a liquid nitrogen-fueled Instec HCP 204S thermal plate set at −40° C. for 10 minutes. The flow of liquid nitrogen was controlled by an Instec mK2000 temperature control unit and an Instec LN2-P liquid nitrogen pump to maintain the mixture in the nematic phase. Subsequently, the thermal plate temperature was raised to −20° C. for 3 minutes to facilitate alignment of the LC with the aligning surfaces. The temperature was then reduced to −40° C. for another 10 minutes prior to polymerization. In all three methods, polymerization was carried out using a 365 nm-wavelength UV lamp emitting 10 mW/cm² for 15 minutes. Gravimetric analysis was employed to determine the polymerization kinetics, specifically measuring the conversion of non-LC monomer and crosslinker, with samples extracted from the polymerizing mixture at different time intervals.

LC removal via solvent extraction after polymerization. After polymerization, the LC-infused polymer films underwent a four-day immersion in organic solvents for LC extraction. Various solvents were employed to assess their impact on the properties of the polymer film. Taking PMMA as an example, used acetone and chloroform as good solvents, methanol and tetrahydrofuran as poor solvents, and dimethyl sulfoxide as a theta solvent. Following solvent exposure, the films were rinsed with water and dried before subsequent testing.

Characterization of LC orientation and polymer chain alignment. The orientation of the LC/monomer system before and after polymerization, as well as the alignment of polymer chains in the polymer films formed through polymerization in LCs after LC removal, were visualized using an Olympus BX53M polarized light microscope equipped with dual polarizers. Additionally, the orientation of the polymer chain alignment was determined through wide-angle X-ray scattering (WAXS).

Characterization of phase behavior of LC-templated polymer films. The phase behavior of polymer films formed through polymerization in LCs was characterized through polarized light microscopy imaging and differential scanning calorimetry (DSC) analysis. DSC was performed on a TA Instruments DSC 2500 instrument equipped with a TA RSC90 refrigerated water cooler. Heating and cooling cycles were conducted at a ramp rate of 5° C./minute.

Characterization of dielectric properties of LC-templated polymer films. The dielectric properties of the polymer films formed through polymerization in LCs, both before and after LC removal, were evaluated using a Novocontrol High-Resolution Alpha Dielectric Analyzer, coupled with a Quatro cryogenic temperature control system. Measurements were conducted over a frequency range of 10-1 Hz to 107 Hz and temperatures ranging from 25° C. to 0° C., with an accuracy better than +0.1 K. The samples were evaluated using a parallel plate capacitor geometry, with a diameter of 3 mm and a gap of 100 μm for the polymer films, and a diameter of 15 mm and a gap of 330 μm for the LCs. Glass rods, 100 μm in diameter, were incorporated into the optical cells and polymerized into the film as spacers.

Characterization of shape deformation of LC-templated polymer films. After LC removal, the LC-templated polymer films were extracted from the optical cells and trimmed to dimensions of approximately 10 mm by 4 mm. Subsequently, photographs of the polymer films were captured at various temperatures, and their dimensional changes were quantified using a custom MATLAB code capable of measuring uniaxial and curling deformations.

Polymerization in chiral LCs. Polymerization in chiral LCs follows the same procedure as previously described, with the addition of chiral dopants to the LC/monomer mixture. For this study, R1011 and R811 were selected as chiral dopants. The composition of the chiral dopants added to the mixture was varied to adjust the pitch and light reflectance of chiral LCs. For instance, to create a film with a metallic green reflection, 200 μL of E7, 23 μL of MMA, and 5.5 μL of HDDA were mixed with 20.78 mg of R811 and 14.1 mg of R1011, resulting in concentrations of approximately 7.8 wt % and 5.3 wt %, respectively.

The transmission/absorbance of the chiral LC-templated polymer films was measured using an Agilent Cary 5000 Series UV-Vis-NIR Spectrophotometer equipped with a dual solid sample holder fixture. The films were placed in the optical cell and inserted into the front slot of the holder, while an empty cell was placed in the rear slot as a reference sample. The instrument settings included an average time of 0.100 second, a data interval of 0.667 nm, and a scan rate of 200 nm/min. The wavelength range scanned was from 800 nm to 200 nm, with a spectral bandwidth set at 2 nm.

Electric field-induced switching of transmittance in chiral LC-templated polymer films. The chiral LC-templated polymer films were made by following the same procedure as described earlier, with the exception of using ITO-coated glass slides instead of regular glass slides. The coated side of the ITO glass slides was confirmed by checking the resistivity of the surfaces, and an additional layer of Elvamide® was applied. After polymerization, the optical cells were connected to a power supply capable of delivering a specific voltage and current to induce the desired switching/tuning effect, achieved by clamping alligator clips onto both glass slides.

Conclusion. In conclusion, the study experimentally realizes de Gennes' predictions regarding the alignment of polymer chains through the ASAP method. This method utilizes polymerization in a non-reactive nematic LC solvent at low temperatures, achieving aligned chain conformation in intrinsically amorphous polymers. Remarkably, this alignment can be kinetically preserved even after LC removal due to proper crosslinking density during polymerization and unfavorable interactions between the resulting polymer and the solvent for LC extraction, which is contrary to de Gennes' 2^{nd} prediction. As a result, manipulating the temperature profile allows for control over the reversibility of shape morphing in the resulting polymer network, such as switching between one-way and two-way shape memory effects. The versatility of the ASAP method extends to a variety of amorphous polymers and LC mesophases, allowing for significant adjustments in shape actuation temperatures and enabling the stabilization of chiral phase LCs. Overall, the ASAP method overcomes challenges posed by the chemical structure of intrinsically amorphous polymers, opening up their innovative applications in diverse fields, from soft actuators and robotics to optics. It is contemplated that the ASAP method can be used for aligning chains of polymer electrolytes with enhanced directional lithium-ion conductivity and optimizing the conformation of inherently disordered conducting polymers for improved charge carrier mobility.

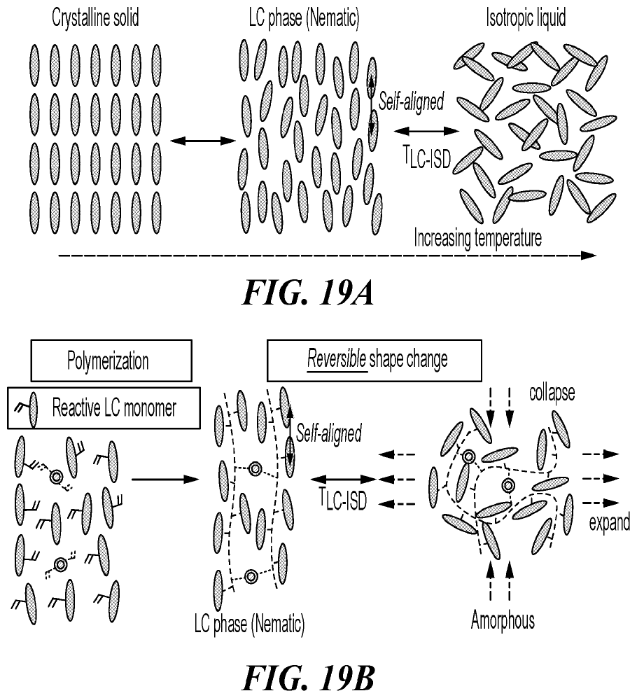

Example 2: From disposable cups to soft robotics-Enabling reversible shape changes in amorphous polymers. Two-way shape-memory polymer (SMP) design relies on the stretching, aligning, and packing of polymer chains. These aligned polymers are crosslinked together, where shorter segments are used to connect longer strands together, like the steps of a ladder (FIG. 19B). This crosslinking process helps polymers remember their original shape so that they can return to it and causes the shape of the material to change as the polymer chains switch their conformations. The challenge of creating two-way SMPs out of less expensive amorphous polymers is that they do not automatically align, preferring instead to remain in a jumbled mess like a bowl of spaghetti (FIG. 18). In contrast, LCs readily align without any outside influence. These materials often exist in what is called the nematic phase, where the LCs self-align into a unified direction but are randomly distributed in space (FIG. 19A).⁷ Previously, LCs have been attached to the side of polymer chains, as seen in FIG. 19B. After some light crosslinking, these new materials, referred to as liquid crystal elastomers (LCEs), exhibit reversible shape changes in response to external stimuli. This two-way shape memory effect is observed when the temperature increases beyond the phase transition temperature of the LCs, allowing the LCs to go from the aligned nematic phase into an unaligned, isotropic phase. This then allows the polymer chains to reversibly switch their conformation.^{8,9} However, incorporation of expensive and relatively toxic LCs as part of the polymer chains both limits their use in bio-related applications and greatly increases their cost. Here, the self-aligning properties of LCs are exploited to stretch and align polymer chains without bonding them to the structure. A new class of low-cost soft actuators and soft robotics with controllable shape changing properties and increased biocompatibility can be realized with the synthesis of two-way SMPs through polymerizing widely used amorphous monomers in non-reactive LC solvents that can be removed after polymerization.

The LC templating method can be used to upcycle lower-value polymeric products into two-way SMPs and provide for a new class of soft robotics based on amorphous polymers for targeted in-body drug delivery or long-term implementation with reduced chance of rejection.

Referring now to FIG. 20, the LC templating method is used to polymerize and crosslink non-crystalline monomers and crosslinkers in a non-reactive LC solvent, creating stretched and aligned chains. The glass substrates that make up the reaction vessel were chemically coated to guide the alignment of the LC solvent, which will in turn guide the polymer chain alignment. It is shown that (1) the alignment of the LC solvents can stretch and align the polymer chains through interactions between the LCs and the amorphous monomers, and (2) after removing the LCs, the polymer chains can reversibly switch conformations in response to external stimuli.

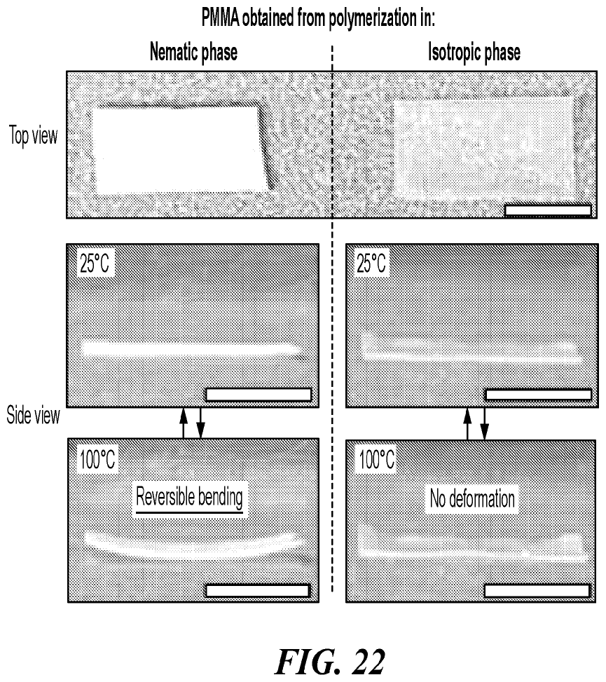

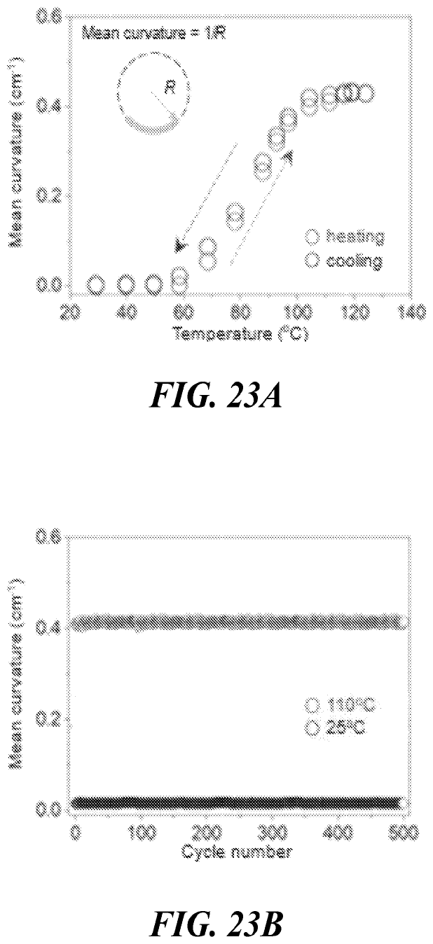

The polymerization of non-crystalline monomer methyl methacrylate (MMA; 16% wt) and the non-crystalline crosslinker 1,6-hexanediol diacrylate (HDDA; 4% wt) in E7 (80% wt) was performed between a polyimide-coated glass slide and a silane-functionalized glass slide to align the E7 tangentially and perpendicularly to the surface, respectively at −70° C. After polymerization and the removal of E7, the resulting PMMA film exhibited a reversible bending deformation with an actuation temperature of ~60° C. (FIGS. 22 and 23A), which was repeated for at least 500 cycles without any deterioration (FIG. 23B). These shape changes are strikingly similar to the characteristic changes of LCEs and semicrystalline polymer-based two-way SMPs.^{3-6,8,9} In contrast, PMMA films polymerized in either isotropic phase (at 25° C.) or non-structured solvents (e.g., toluene) exhibit no measurable shape change upon heating (FIG. 22). More importantly, this reversible shape change seen during heating has also been achieved in polystyrene polymerized in nematic E7, showing that the LC templating method can be used for a wide range of monomers.

In addition to PMMA and polystyrene (with glass transition temperatures of ~105° C. and ~100° C., respectively), polymer films made from other non-crystalline monomers with lower glass transition temperatures [e.g., n-butyl acrylate (nBA; ~−54° C.), t-butyl acrylate (tBA; ~50° C.), methyl acrylate (MA; ~10° C.) and 2-ethylhexyl acrylate (EHA; ~-50° C.)] and non-crystalline crosslinkers (FIG. 24) were tested. It is contemplated that polymer films can be made through different polymerization methods and mechanisms (e.g., ring-opening, polyaddition, and click polymerization). These different monomers can be used to control the actuation temperature and mechanical strength of the films to create low-cost two-way SMPs that can compete with conventional LCEs and semicrystalline polymer-based two-way SMPs.

Structure-property relationships of polymers formed in LCs. Design rules are presented to develop two-way SMPs based on a fundamental understanding of the relationships between the polymer chain conformations and shape changes of the films.

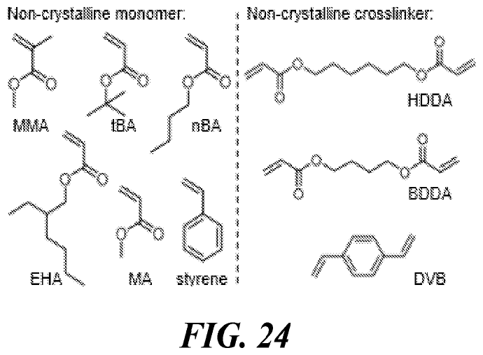

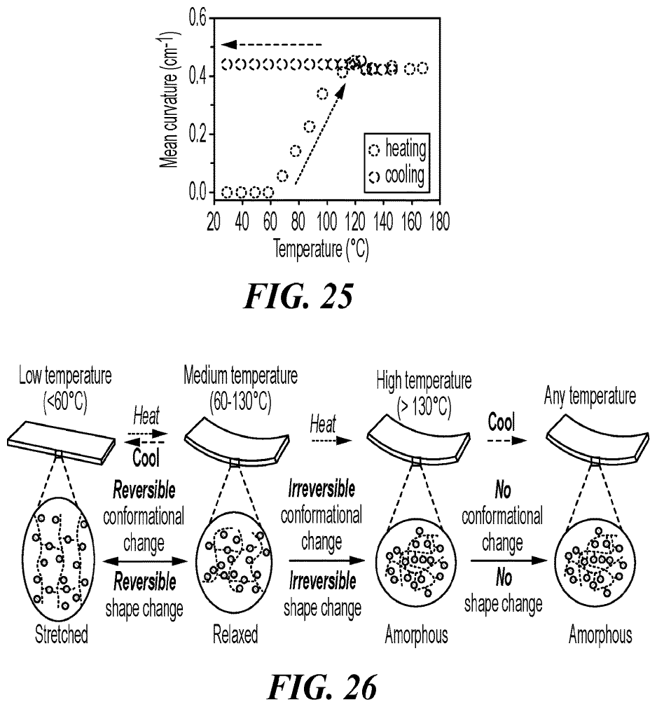

Differential scanning calorimetry (DSC) and systematic property studies were used to determine the temperature that would cause the alignment of the polymer chains to permanently transition to the preferred random coil conformation, leading to an irreversible shape change. Through these experiments, it was found that once the PMMA film was heated above 170° C. and then cooled to room temperature, it remained bent and did not return to its original, flat shape (FIG. 25). Below a threshold temperature the glass transition temperature of the crosslinked PMMA film, the polymer chains can be reversibly switched between a stretched and a relaxed conformation (FIG. 26, left). However, at high temperatures, there exists an irreversible transition where the polymer chains relax too far and cannot return to a stretched state even after cooling. As a result, this ‘stretched-relaxed’ transition no longer exists, and the polymer networks are not capable of reversible shape change (FIG. 26, right).

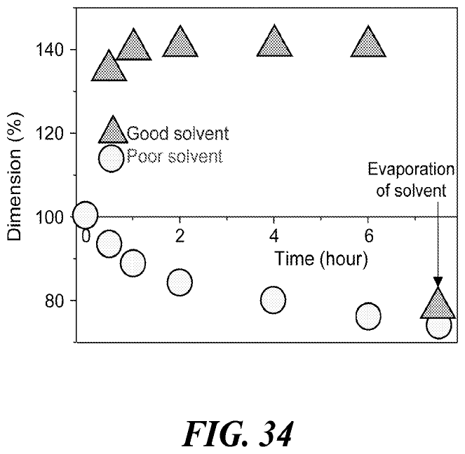

Ethanol, which was used to dissolve and remove E7, is a poor solvent for PMMA, meaning that the polymer will not swell in ethanol. During the LC removal process with ethanol, the preference for polymer-polymer interactions does not provide the space or mobility needed for the polymer chains to relax away from their stretched conformation. As a result, the stretched conformation and alignment of the polymer chains was preserved even after removing the LCs (FIG. 20B, top). Therefore, a good solvent for PMMA (i.e., one that the polymer prefers more than itself) will give rise to significant swelling, which result in the polymer chains losing their alignment and relax out of their stretched conformation (FIGS. 20B and 20C, bottom). To test this hypothesis, how solvent-polymer interactions affect the swelling of the crosslinked polymer and the polymer chain conformations and alignment after removing the LC was investigated (see FIG. 34). Solvents with different polarities were used, and the crosslinking density was adjusted during polymerization to determine the effect that the solvent and crosslinking density have on the polymer chain conformations and shape changes using small angle/wide angle X-ray scattering (SAXS/WAXS) and optical and electron microscopy.

It was found that a ‘stretched-relaxed’ transition exists as a new phase transition, which is similar to the nematic-isotropic phase transition of conventional LCEs (FIG. 19B). The phase transition temperature(s) of the films polymerized in different solvent conditions (E7 in different phases and toluene) were determined by DSC, and the polymer chain conformation and alignment in films were measured at different temperatures and with different thermal histories.

Upcycle lower-value amorphous polymers into higher-value two-way SMPs. Polymers are an indispensable part of our global society and are used in a wide variety of applications, including packaging, building/construction, consumer products, and textiles. They are lightweight, durable, chemically resistant, moldable, and inexpensive, and are used in thousands of products that add comfort, convenience, and safety to our everyday lives. However, due to their convenience and versatility, polymers have created a new challenge: global polymer production has reached a rate of more than 400 million metric tons per year, but only ~20% of the discarded plastics are recycled. For example, in 2017, polystyrene accounted for 8% of global polymer production, with major uses in packaging and building (e.g., packing peanuts, Styrofoam cups and food containers, and foam board insulation), yet only 1% was successfully recycled.¹⁰ Current approaches to reducing unwanted plastics include landfilling, mechanical recycling (e.g., shredding and remolding), chemical recycling (e.g., hydrolysis, pyrolysis, and gasification), and burning (e.g., heat generation). As opposed to recycling, the upcycling of polymeric products, in particular amorphous polymers, to increase their value, quality, and lifetime and reduce waste remains difficult. This technological gap presents an opportunity for fundamental research into the chemical upcycling of lower-value polymers into higher-value products.

To address this gap, and the growing accumulation of discarded polymeric products, the LC templating method can be used to chemically upcycle lower-value amorphous polymers into two-way SMPs through aligning the chains of lower-value polymers and crosslink them in an LC solvent. For example, Styrofoam cups and food containers can be dissolved into nematic E7 and crosslinked to create two-way SMPs. The E7 can be collected and reused after polymerization.

To investigate the effect of the length of polymer chains on the polymer's ability to be dissolved and aligned by the LCs, existing depolymerization methods (e.g., microwave assisted pyrolysis of polystyrene) were used to create different chain lengths. Finally, other acrylate- and polyaddition-based polymeric products were tested. This upcycling route provides extra economic benefit to the collection and recycling of waste plastics.

Discussion. The proposed method significantly broadens the monomer library for two-way SMPs and yields a blueprint in the rational design and chemical upcycling of conventional, lower-value amorphous polymers that are normally unable to exhibit reversible shape changes. Results will open up entirely new ways to utilize non-reactive LC solvents to introduce stretching and alignment to the chains of amorphous polymers. It is contemplated that this method will be applied to the creation of a new class of easily synthesized shape changing polymers that can be derived from commodity monomers and will revolutionize the soft robotics field with the development of biocompatible and biodegradable two-way SMPs for a wide range of applications. Finally, considering the tremendous switch from liquid crystal displays (LCDs) to light emitting diode (LED) displays, this disclosed method expands the potential utility of LCs from display technology into material synthesis, which will provide an outlet for the existing LC industry and will draw future resources to these fascinating LC materials.

Example 3: Controlling Chain Conformation in Amorphous Polymers through Soft Nanoscale Confinement. Two-way shape memory polymers (SMPs) that respond to environmental cues with programmable and reversible shape deformations have shown great potential in applications ranging from sensors to soft actuators and robotics. The reversible shape deformations of two-way SMPs are commonly created by switching between two phases where the polymer backbones adopt distinct conformational states, e.g., a stretched conformation at low temperatures and a random coil at high temperatures. Current two-way SMPs rely on polymers with intrinsic crystallinity, such as semicrystalline polymers and liquid crystal elastomers (LCEs), which require specific chemical structures to induce intermolecular packing that stretches and aligns the polymer chains. However, the monomers used to prepare these polymers are expensive and often require complicated synthesis procedures. They may also possess functional groups that are not economically sustainable or biocompatible.

In contrast, intrinsically amorphous polymers, such as polystyrene, are inexpensive to prepare and are already widely used in many applications. However, amorphous polymers lack the nanoscopic characteristics necessary to induce stretched chain conformations and cannot reversibly switch between two conformational states. The stretching and alignment of amorphous polymers has been attempted through polymerizing the amorphous, non-LC monomers in non-reactive liquid crystals (LCs), leading to LC organogels or polymer-dispersed liquid crystals (PDLCs; FIG. 3B). In the case of LC gels, the LC solvent remains in the isotropic phase throughout the entire polymerization process, whereas in the case of PDLCs, the LC solvent is originally in the isotropic phase and transitions into the nematic phase as polymerization induced phase separation occurs. However, in both cases, the polymer chains are not unidirectionally stretched and aligned and do not exhibit reversible shape deformations with respect to an external stimulus.

Unlike in the creation of LC gels and PDLCs, this proposed research seeks to investigate the polymerization of amorphous polymers in a LC solvent that is in the LC phase during the entire polymerization process, as seen in FIG. 3C. In 1969, Pierre-Gilles de Gennes made the following prediction: “[The] crosslinking of intrinsically isotropic polymers (amorphous, non-LC polymers) into a network in the presence of a nematic LC solvent acts to imprint LC order into the polymer network. On removal of the LC solvent, the intrinsically isotropic chains in the polymer network cannot remember the anisotropy pertaining at the moment of genesis of their topology. The polymer chains can relax without major obstacles towards an isotropic conformation.” While de Gennes' prediction discourages the possibility of preserving stretched conformations in intrinsically isotropic polymers upon the removal of the LCs that induced the stretched conformations, the results have shown that crosslinked polystyrene networks polymerized in nematic LCs can exhibit a high degree of alignment and reversible shape deformations even after the removal of the LCs.

Theoretical backgrounds. The effect of LC nanoconfinement and the removal of the LCs on the polymer chain conformation and alignment of non-LC polymers networks synthesized in non-reactive LCs were investigated. The scalar order parameter was used to quantify the orientational order of the LC mixture before and after polymerization and the polymer network after removing the LCs. The scalar order parameter(S) is defined as⁷:

$$S = \frac{1}{2} ( 3 〈 {cos}^{2} β 〉 - 1 ) \qquad ( 1 )$$

where β is the angle between the molecular symmetry axis and the LC director. The extent that nematic LCs translate their scalar order parameter to the non-LC polymer networks polymerized in the LCs was investigated using polarized light microscopy and wide angle X-ray scattering (WAXS). The scalar order parameter of the LC mixture prior to polymerization was determined by measuring the mixture's birefringence using a polarized light microscope and Berek compensator, followed by Haller's extrapolation method and Vuks' hypothesis. Specifically, the scalar order parameter can be calculated as:

$$S ( \frac{Δα}{α} ) = \frac{{n}_{e}^{2} - {n}_{o}^{2}}{〈 {n}^{2} 〉 - 1} \qquad ( 2 )$$

where Δα is the anisotropy of polarizability, a is the mean molecular polarizability, n is the measured refractive index, and n_{c} and nₒ are the extraordinary and ordinary refractive indices of the LC, respectively. By plotting log

$$( \frac{{n}_{e}^{2} - {n}_{o}^{2}}{〈 {n}^{2} 〉 - 1} )$$

as a function of log

$$( 1 - \frac{T}{{T}_{N - I}} ) ,$$

Δα/α was obtained from the intercept at T=0K where the complete order occurs (S=1). By inserting the obtained value of Δα/α into Equation 2, the scalar order parameter of the LC mixture was calculated at different temperatures.

To quantify the alignment of the polymer chains, the scalar order parameter of the crosslinked polymer network was determined before and after removing the LCs with WAXS. The [symbol] cos² β [symbol] term in Equation 1 was calculated from the two-dimensional WAXS pattern (X-ray scattering as a function of azimuthal angle and momentum transfer) using:

$$〈 {cos}^{2} β 〉 = {\sum }_{n = 0}^{5} \frac{{f}_{2 n}}{2 n + 3} / {\sum }_{n = 0}^{5} \frac{{f}_{2 n}}{2 n + 1} \qquad ( 3 )$$

$$I ( θ ) = {f}_{0} + \frac{2}{3} {f}_{2} {cos}^{2} θ + \frac{8}{15} {f}_{4} {cos}^{4} θ + \frac{16}{35} {f}_{6} {cos}^{6} θ + \frac{128}{315} {f}_{8} {cos}^{8} θ + \frac{256}{693} {f}_{10} {cos}^{10} θ \qquad ( 4 )$$

in which I and θ are the normalized scattering intensity and scattering angle, respectively. In addition, the WAXS patterns were used to determine the alignment of the polymer chains with respect to the LC director, which was determined by the polyimide glass rubbing direction.

Experimental Methods. To provide further insight into the polymer chain packing and alignment, an infrared transition moment orientational analysis (IR-TMOA) method was used to study the orientation of different moieties (e.g., ester groups and aliphatic backbones) in the non-LC polymer network. The method relied on the variation of IR-absorption spectra depending on the linear polarization of the incident electric field and the inclination of the sample with respect to the optical axis. The result was expressed as an order parameter matrix, bearing five independent quantities: three determining the orientation of the distribution in the laboratory reference frame and two describing the width of the distribution, i.e., the degree of alignment or the order. Each molecular moiety had a specific signature in the IR spectrum making it possible, in many cases, to determine the unique distribution function for a selected molecule group. Thus, the IR-TMOA method measured the generalized order parameter in an analogous way to those described by White and Spruiell (White, J. L.; Spruiell, J. E., Polym. Eng. Sci. 1981, 21 (13)) and Stein (Stein, R., J. Appl. Phys. 1961, 32 (7)) . . . . This method enabled the quantification of the orientation of specific moieties in the polymer network, thereby yielding a quantitative picture of the packing and alignment of polymer chains formed in nematic LCs.

Additional studies were conducted to understand the stability of the stretched polymer chains and the reversibility of their deformations by applying different external stimuli such as heat and other solvents. From this study, a framework to correlate the orientational order of the LC solvent before polymerization to the orientation of the synthesized polymer network after polymerization and removal of the LCs was developed. The orientational order of the LCs and polymer films using polarized light microscopy and WAXS was studied. The phase behaviors and macroscopic shape changes of the polymer films formed throughout the proposed research were analyzed using differential scanning calorimetry (DSC) and optical microscopy.

Elucidating the impact of LC nanoconfinement on chain conformations and alignments upon polymerizing non-LC monomers in non-reactive LC solvents. Past studies have shown that polymerizing non-LC monomers in LC solvent results in either LC gels (where the LCs are in the isotropic phase throughout the entire polymerization process) or PDLCs (polymerization-induced phase separation between the formed polymer network and LC solvent with an accompanying isotropic-nematic phase transition). However, the effects from polymerizing non-LC monomers in LC solvents that remain in the nematic phase during the whole process have not been thoroughly explored. The first objective of the proposed work is to understand the impact of LC nanoconfinement on polymer chain conformations by polymerizing a non-LC monomer and a non-LC crosslinker in a nematic LC solvent. 2,2-Dimethoxy-2-phenylacetophenone (DMPAP) will be used as a photoinitiator. An LC mixture containing both cyanobiphenyl and cyanoterphenol components, E7 (FIG. 5), was used as the non-reactive LC as E7 resides in the nematic phase over a wide temperature range (from −62° C. to 60° C.). A mixture of non-LC monomer, non-LC crosslinker, DMPAP, and E7 was photopolymerized in a reaction vessel made with chemically functionalized glass slides that control the surface ordering and thus the bulk orientation of E7. The polymerization temperature was tuned to guarantee that the E7 will be in the nematic phase during the entire polymerization process. The conversion of the non-LC monomers and crosslinkers was determined using both a gravimetry method and nuclear magnetic resonance (NMR). The intrinsic long-range orientational order of the LCs can stretch and align the formed polymer chains via non-covalent LC-polymer interactions during the polymerization process in the nematic LC solvent, as shown in the work to polymerize styrene and 1,6-hexanediol diacrylate (HDDA; a non-LC crosslinker) in nematic and isotropic E7.

Results. The polymerization of styrene (10% wt) and HDDA (2.5% wt; FIG. 2), in E7 (87.5% wt, FIG. 2) was performed in an optical cell by paring two polyimide-coated glass slides together with 50 μm spacers. DMPAP was added at 2 wt % based on the mass of styrene and HDDA. Nematic LCs, such as E7, have been shown to adopt a parallel ordering at the surface of the rubbed polyimide-coated glass slides, as shown in FIG. 21. The polymerization temperature was tuned to control the LC phase during polymerization.

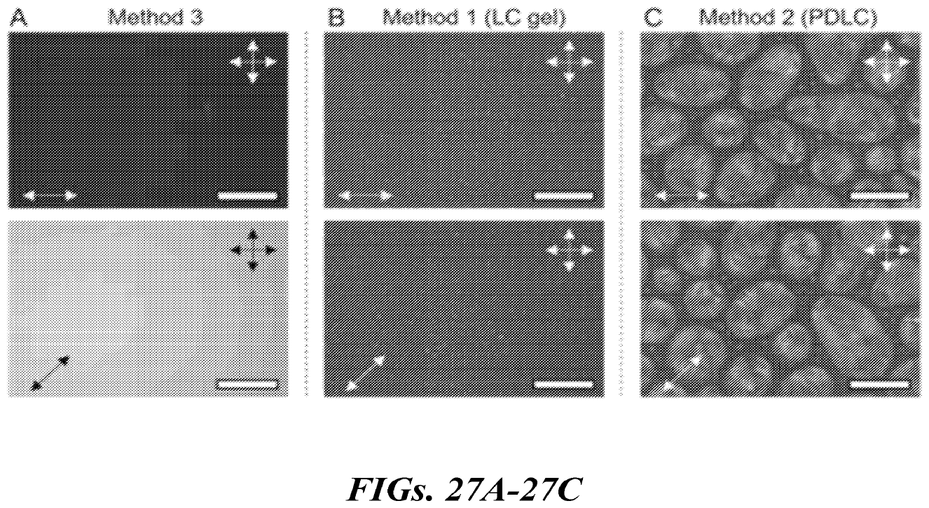

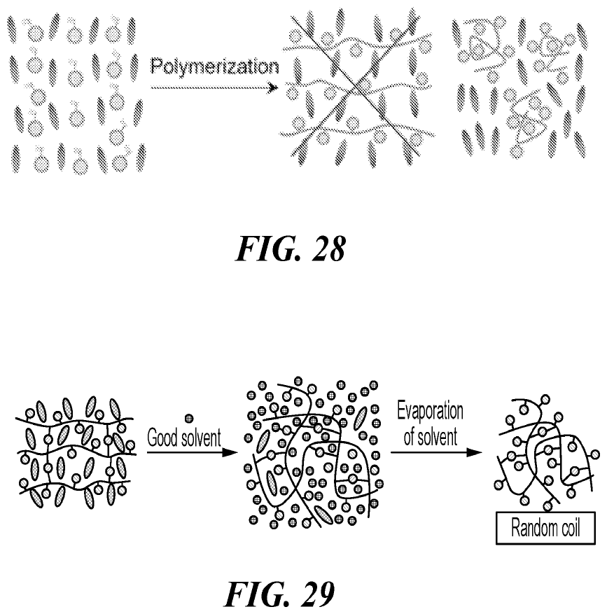

The mixture was polymerized at −60° C. using UV radiation (with a wavelength of 365 nm) for 30 minutes. The low temperature was required to guarantee the mixture stayed in the nematic phase for the entire polymerization process (FIG. 3C) because the presence of a non-LC species lowers the nematic to isotropic phase transition temperature (T_{N-I}) and melting temperature of LCs and can also cause the isotropic and nematic phases to coexist within the mixture. The phase transition temperature between this coexisting isotropic/nematic phase and the uniform nematic phase for this mixture was measured to be −30° C. using both polarized light microscopy and DSC. Next, polarized light microscopy was used to characterize the morphology and optical appearance of the E7-infused crosslinked polystyrene network after polymerization. As shown in FIG. 27A, a uniform, bright optical appearance was observed when the film was rotated to an angle between 0° and 90°, with the brightest at 45°, which confirms that the polystyrene chains were not negatively affecting the orientation of the unidirectionally aligned E7 and were instead stretched and aligned with the E7 (FIG. 3C).

Next, the optical appearance of the polystyrene films prepared using LC solvent in isotropic states (see FIGS. 3A and 3B) were compared. The E7-infused polystyrene film formed in isotropic E7 with a polymerization temperature of 70° C. (T_{N-I} of E7 is 60° C.; FIG. 3A) exhibited a dark appearance at all angles of rotation under a polarized light microscope at 70° C. Upon cooling to room temperature (25° C.), the uniformly dispersed E7 transitioned to the nematic phase illuminating the well-dispersed LCs, a characteristic behavior of LC gels, as shown in FIG. 27B. In contrast, the E7-infused polystyrene films that were polymerized at room temperature followed the typical polymerization-induced phase separation process of PDLCs, meaning that the mixture was in the isotropic phase when the polymerization began but slowly transitioned to the nematic phase as the LC solvent and polymer network phase separated (FIG. 3B). As can be seen in FIG. 27C, the formed E7-infused polystyrene films exhibit a polydomain morphology at all angles of rotation, a characteristic behavior of PDLCs. Thus showing that polymerizing non-LC monomers in a nematic LC solvent throughout the entire polymerization process (FIG. 3C) leads to a stretched and aligned polymer network templated by the LCs,

To elucidate the impact of LC mesophases on polymer chain alignment and the role of LC nanoconfinement on polymer chain conformations, the extent that nematic LCs translate their orientational order to the non-LC polymer networks polymerized in the LCs was investigated. A correlation between the scalar order parameter of the mixture of LCs and non-LC monomers (before polymerization) and the LC-infused polymer networks formed by these three polymerization methods was established. The scalar order parameter was quantified by measuring the mixture's birefringence using a polarized light microscope and Berek compensator as well as with WAXS measurement.

In addition to the polymerization methods, the composition of the non-LC monomers and crosslinkers, which affect the phase behavior of the mixture, were also investigated following the same experimental procedure. An increase in the composition of non-LC species decreases the phase transition temperature and thus the scalar order parameter of the LC mixture prior to polymerization. In particular, it was expected that the crosslinking density plays a critical role in the preservation of the chain conformations imprinted by the E7 during polymerization because the intrinsically isotropic polymers lack any inherent crystallinity to stretch the polymer chains. At low crosslinking densities (FIG. 29), the polymer chains do not preserve the stretched conformations and relax back into random coils and phase separate from the bulk E7. This is shown in the following experiments where mixtures of monomers and crosslinkers in E7 were polymerized with different ratios of crosslinker to monomer.

In addition to styrene (with a glass transition temperature ~100° C.), other non-LC monomers with different chain rigidities and corresponding glass transition temperatures were studied, including methyl methacrylate (MMA; ~105° C.), n-butyl acrylate (nBA; ~-54° C.), t-butyl acrylate (tBA; ~50° C.), methyl acrylate (MA; ~10° C.), and 2-ethylhexyl acrylate (EHA; ~−50° C.), as shown in FIG. 24. The effect of the rigidity of the non-LC crosslinkers was also investigated, e.g., 1,4-butanediol diacrylate (BDDA) and divinyl benzene (DVB), as shown in FIG. 24. It is contemplated that polymer networks with a lower chain stiffness (indicated by a low glass transition temperature in the respective homopolymer) will require higher crosslinking densities to preserve the stretched chain conformations, compared with the polymers with more rigid chains.

Results. It was contemplated that the stretched and aligned polymer chains can be preserved by selecting a proper solvent to remove the LCs, as illustrated in FIG. 20. In the present study, ethanol was used to extract the E7 from the polystyrene network, and the complete removal of E7 was confirmed by Fourier-transform infrared spectroscopy (FTIR; based on the nitrile group peak of E7 at around 2,100 cm-1). After extracting the E7, polarized light microscope imaging confirms that the crosslinked polystyrene film polymerized in nematic E7 at −60° C. (Method 3) exhibited a uniform, bright optical appearance when the film was rotated to an angle between 0° and 90°, with the brightest at 45°, similar to that of the E7-infused polystyrene network (FIG. 26A). This observation suggests that the stretched and aligned polymer chains were preserved even after removing the LCs. In contrast, after extracting the E7 from the crosslinked polystyrene film obtained in Methods 1 and 2, a dark appearance was observed at all angles of rotation under a polarized light microscope, indicating a disordered alignment of polymer chains adopting random coil conformations.

The stretched conformation and unidirectional alignment of polymer chains obtained from polymerizing in a nematic phase LC can be preserved even after removal of the LCs and evaporation of the solvent. It is contemplated that this is attributed to the solvent-polymer interactions during the LC removal process. Ethanol, which was used to dissolve and remove the E7, is a poor solvent to polystyrene. During the LC removal process with ethanol, polymer-polymer self-interactions are preferred and the resulting contraction does not provide the free volume needed for the polymer chains to relax towards a random coil, which are the most thermodynamically stable chain conformations for intrinsically amorphous polymers. As a result, the stretched polymer chains undergo an anisotropic shrinkage, i.e., a preferential shrinkage in the direction parallel to the polymer chain alignment, leading to a preservation of the alignment even after removing the LCs. Therefore, when a good solvent, with respect to the polystyrene, is used to remove the LCs, the preferred solvent-polymer interactions will give rise to significant swelling, which will allow the polymer chains to reorganize into random coil conformations, as shown in FIG. 20.

Solvent-polymer interactions on (i) the swelling ratio of the crosslinked polymer networks, (ii) the shrinkage of the polymer networks during the solvent evaporation, and (iii) the polymer chain conformation and alignment upon removal of the LCs. A variety of solvents with different solvent-polymer interactions for the monomers listed in FIG. 24 were studied, such as toluene and dichloromethane as good solvents, and methanol and ethanol and acetone as poor solvents, and cyclohexane and diethyl malonate as a theta solvent for polystyrene. Crosslinked polymer networks were prepared using two polyimide-coated glass slides, and the changes in the dimensions were quantified (in both the solvent swelling and solvent evaporation processes) of the polymer network along different directions (e.g., parallel and perpendicular to the chain alignment or the polyimide rubbing direction). Preferential shrinkage of main-chain LC polymeric networks perpendicular to the local LC polymer chain alignment are known to occur, and thus, resulting in an anisotropic shrinkage of the polymer network with respect to the alignment of the polymer chains provided by Method 3 as shown in FIG. 3C, and a shrinkage in an isotropic manner in the polymer networks polymerized in Methods 1 and 2 of FIGS. 3A and 3B, respectively.

Because the respective polymers are intrinsically amorphous, it was necessary to understand the way that the polymer chains pack in the crosslinked polymer networks polymerized in nematic LCs after removal of the LCs. Therefore, the internal structure of the formed polymer network was characterized after the removal of the LCs. The scalar order parameters of the crosslinked polymer networks were quantified with WAXS and correlated with the scalar order parameters of the LC prior to polymerization and after polymerization before LC removal. In addition, WAXS patterns were used to determine the alignment of the polymer chains with respect to the LC director, which is determined by the polyimide glass rubbing direction (see FIG. 8).

Understand the stability and phase behavior of polymer networks synthesized in liquid crystals. Considering the fact that the equilibrium state of the intrinsically amorphous polymer chains is a random coil, the stability of the stretched conformation and the phase behavior of the crosslinked polymer networks synthesized in nematic LCs (FIG. 3C) after removing the LCs, as shown in FIG. 20, were studied. It is well established that the shape deformability of LCEs, such as the actuation temperature and locomotion, correlate with their polymer chain conformation and phase behavior. A relationship between the chain structures (e.g., chain conformation and alignment) and properties (e.g., phase behavior and shape deformability) of the polymer networks are utilized in the disclosed method.

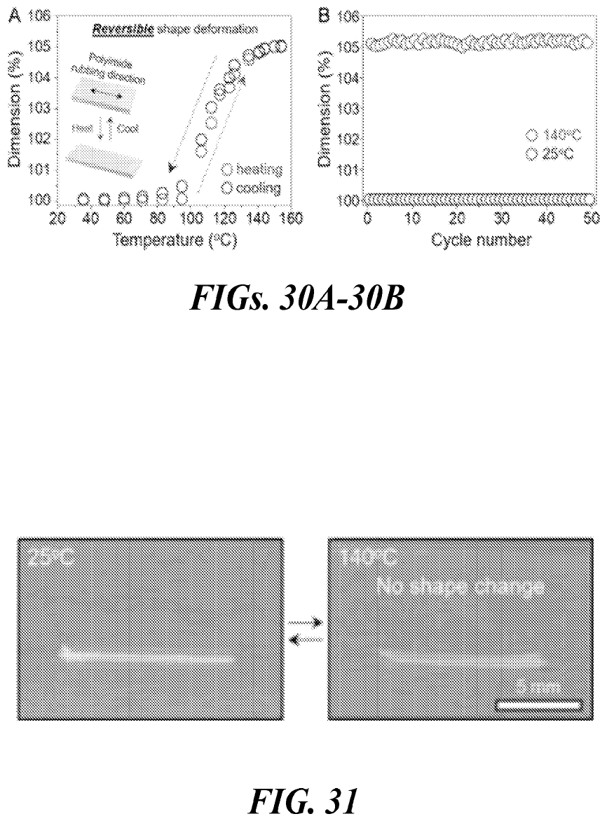

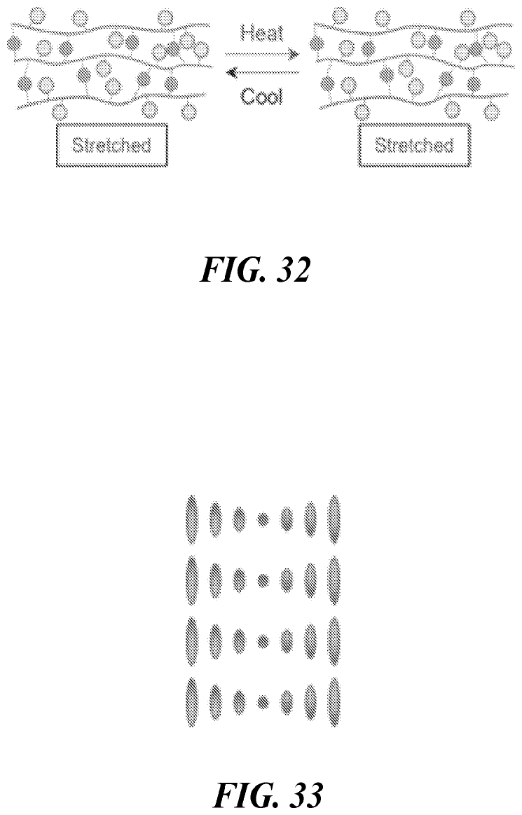

Results. After polymerizing in and removing nematic E7 using ethanol, the resulting polystyrene films exhibit a reversible unidirectional elongation with respect to the polyimide rubbing direction with an actuation temperature window between ~90-120° C. (FIG. 30A), which was around the glass transition temperature of uncrosslinked, amorphous polystyrene. This reversible elongation was observed for at least 50 cycles without any irreversible deterioration, as evidenced in FIG. 30B. In addition, the polystyrene films prepared in an LC with hybrid bend-splay bulk ordering (a perpendicular and parallel ordering at the surface of silane dimethyloctadecyl[3-(trimethoxysilyl) propyl]ammonium chloride (DMOAP)-functionalized glass slides and rubbed polyimide-coated glass slides, respectively, as illustrated in FIG. 27B, exhibited a reversible bending deformation. The concave side of the bending polystyrene film corresponds to the side oriented by the DMOAP-functionalized glass slide, as shown in FIG. 26. This shape deformation is strikingly similar to the characteristic two-way shape memory effects of LCEs. In contrast, polystyrene films polymerized in an LC with the same hybrid ordering but using either Method 1 or 2 of FIGS. 3A and 3B, respectively, exhibit no measurable bending upon heating, as shown in FIG. 31.

The above results suggest that polymerization in nematic LCs (Method 3 of FIG. 3C) gives rise to aligned, stretched polymer chains, which enable reversible chain conformational changes and thus reversible shape deformations in the crosslinked polymer network. Considering the fact that the equilibrium state of intrinsically amorphous polymer chains such as polystyrene is a random coil, it is considered that the polystyrene chains polymerized in the nematic phase are trapped in a closely packed, stretched conformation that prevents them from easily relaxing towards the random coil conformation. As shown previously, this kinetically trapped barrier can be overcome through heating the polystyrene films to high temperatures. For example, once the polystyrene film was heated above 170° C. for two hours and then cooled down to room temperature, it remained deformed (either elongated or bent) and did not fully return to its original dimensions.

It is contemplated that the stretched chain conformation caused by the nematic E7 solvent creates a new phase transition in addition to the glass transition observed in intrinsically amorphous polystyrene. As illustrated in FIG. 26, below a threshold temperature, which is very likely the glass transition temperature of the crosslinked polystyrene film, the polymer chains can be reversibly switched between a stretched and a relaxed conformation above this new phase transition. The new phase transition is defined as the ‘stretched-relaxed’ transition, which reveals a striking similarity to the nematic-isotropic phase transition of conventional LCEs. Far above this transition temperature, at the suspected glass transition temperature of the crosslinked polymer network, exists an irreversible phase transition where the polymer chains irreversibly reorganize towards the random coil conformation and cannot recover to the stretched state even after cooling. As a result, this ‘stretched-relaxed’ phase transition no longer exists, and the polymer networks are not capable of reversible conformational transitions and shape deformations.

The phase transition temperature(s) of the polystyrene formed in all three methods were determined using DSC, and the scalar order parameters of the polymer networks prepared using different methods and with different thermal histories (e.g., with and without heating to high temperatures) were measured using WAXS and IR-TMOA. It is contemplated that crosslinked polymer networks made of the different monomers in FIG. 24 exhibit different ‘stretched-relaxed’ transition temperatures and distinct irreversibility threshold temperatures.

In these studies (FIGS. 30A-30B and 31), the average length of polystyrene between two adjacent crosslinking points was calculated to be around six repeat units. It is contemplated that there exists a range of crosslinking densities within which the chain conformations in the non-LC polymers that were polymerized in a LC solvent were able to reversibly switch between stretched and relaxed states, thus allowing for reversible shape deformations upon heating. The scalar order parameters were measured together with phase behaviors and shape deformations of the crosslinked polymer networks as a function of temperature to test whether the stretched and aligned polymer chain conformations were preserved. It is contemplated that, at high crosslinking densities, while the stretched polymer chain conformations will be preserved upon LC removal, the polymer chains might lack sufficient free volume to reconfigure upon heating, resulting in a high thermal stability that restricts any conformational changes and measurable macroscopic shape change, as illustrated in FIG. 31. This lack of measurable shape deformations is equivalent to LCNs, which are more densely crosslinked LC polymers.

Extensive LCE studies have shown that the locomotion of an LCE structure is predetermined by the LC ordering. The effect of the LC ordering on the phase behavior and shape deformation of the non-LC polymer networks was studied. In addition to the unidirectionally planar (FIG. 21A) and planar-perpendicular hybrid orientation (FIG. 21B) are a perpendicular (FIG. 21C) and a twisted planar orientation (FIG. 21D). In addition, LCs are well known for their variety of mesophases. To provide more insight into the relationships between the chain conformations and shape deformations of the crosslinked polymer networks, polymerization in other LC mesophases beyond the nematic phase were performed, such as the chiral nematic phase (also known as cholesteric), where LC molecules form a helical twist perpendicular to the director (FIG. 33). Because the cholesteric phase has a distinct LC orientational ordering, it is contemplated that the crosslinked polymer networks polymerized in this phase will exhibit helical chain conformations and twisting shape deformations.

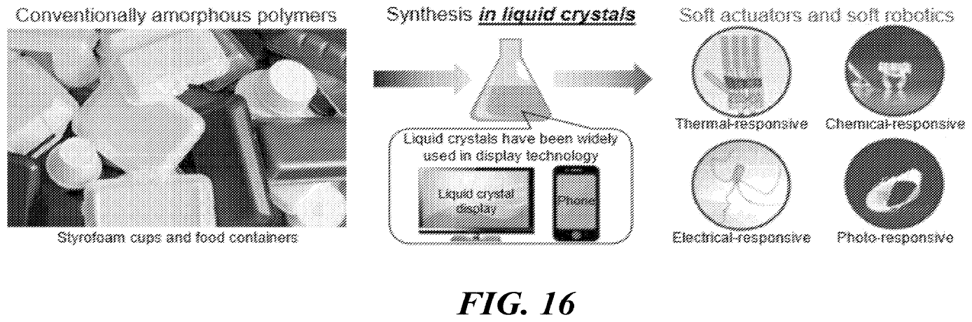

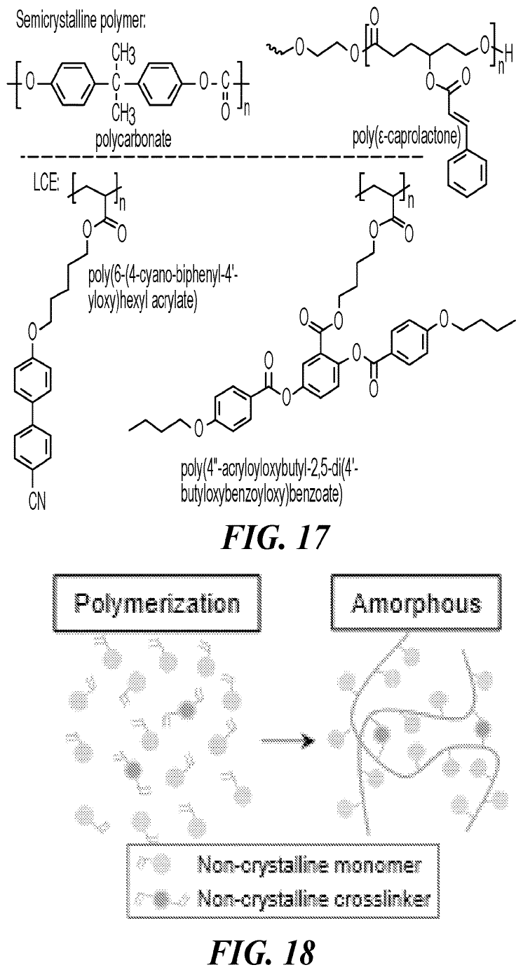

It is contemplated that the disclosed rational design and chemical upcycling of conventional, lower-value amorphous polymers that are normally unable to exhibit reversible shape changes can be transformed into higher-value soft robotics, as shown in FIG. 16. Finally, considering the tremendous switch from liquid crystal displays (LCDs) to light emitting diode (LED) displays, the disclosed method expands the potential utility of LCs from display technology into material synthesis, which will provide an outlet for the existing LC industry and will draw future resources to these fascinating LC materials.

Discussion Liquid crystal elastomer synthesis and development. Because of the general difficulty of creating and preserving stretched conformations in polymer chains, important for the design of two-way SMPs, researchers have turned to LCs and their intrinsic ability to self-assemble and align. In 1975, de Gennes further predicted that a polymer containing LC moieties that is polymerized while in the LC phase (e.g., nematic) will have chains that are stretched away from the high conformational entropy of the random coil. He believed, and it was later proven, that this would be caused by strong enthalpic interactions between the LC groups while they are oriented in the LC phase. LCEs were first realized by Jackson (Jackson Jr, W.; Kuhfuss, H. J. Polym. Sci. Polym. Chem. Ed. 1976, 14, 2043). In general, the synthesis of LCEs requires the incorporation of LC moieties into the polymer chains as either part of the polymer backbone or as pendant functional groups. Finkelmann's work (Finkelmann, H.; Rehage, G. Makromol. Chem. Rapid. Commun. 1980, 1 (12); Finkelmann, H.; et. al. Makromol. Chem. Rapid. Commun. 1981, 2 (4)) led to the development of a one-pot reaction that involved combining linear, non-LC polyhydrosiloxane chains with LC functional groups and crosslinkers to synthesize LCEs. In addition to silicone chemistry, click chemistry between a linear LC polymer or oligomer and a crosslinker has also been utilized in LCE synthesis. Donnio et al (Donnio, B.; et. al., Macromolecules 2000, 33 (21)) catalytically synthesized the first main-chain LCE by reacting a divinylic LC polymer with a chain extender and a crosslinker using this approach. Since then, this click chemistry technique has been widely used in the 3D printing of LCE structures, as established by Ambulo and Kotikian (Ambulo, C. P.; Burroughs, J. J.; Boothby, J. M.; Kim, H.; Shankar, M. R.; Ware, T. H., ACS Appl. Mater. Interfaces 2017, 9 (42); Kotikian, A.; et. al. Adv. Mater. 2018, 30 (10), 1706164). Furthermore, Finkelmann and Zentel presented the synthesis of LCE through polymerization of low molecular weight, reactive LC acrylate and methacrylate monomers while they were aligned in the LC phase. Broer and White have since developed this free radical polymerization technique by refining the selection of LC monomers for LCE synthesis. It is widely recognized that achieving appropriate crosslinking of the LC polymer chains is crucial to the successful design and synthesis of LCEs. If the crosslinking density is insufficient, the polymer chains slip past one another after heating above the T_{LC-I}, completely melting the LCE and preventing it from returning to its original shape. In a densely crosslinked LC polymer network (known as a liquid crystal network (LCN)), however, the movement of polymer chains is largely restricted, which prevents any polymer chain conformational changes and macroscopic shape deformation.

Amorphous polymers synthesized in LCs. Beyond the polymerization of reactive LC monomers, extensive studies have reported the polymerization of non-LC monomers or prepolymers in non-reactive LCs to prepare LC gels and PDLCs. LC gels are created by polymerizing monomers in an LC solvent that remains in the isotropic throughout the entire polymerization process (see FIG. 3A). This is achieved by selecting a specific combination of LC solvent and polymer matrix that forms a stable gel-like structure without inducing phase separation. The resulting material has a homogenous distribution of the LC solvent in the polymer matrix and exhibits unique optical and mechanical properties.

In contrast, PDLCs consist of micrometer- or nanometer-sized LC domains embedded in a non-LC polymer matrix and their synthesis involve a phase separation process during polymerization where the LC solvent initially in the isotropic phase transitions into the nematic phase. The preparation of one of the first examples of PDLCs through the polymerization and crosslinking of a mixture of epoxy oligomers and non-reactive LCs was reported by Zumer (Zumer, S.; Doane, J., Phys. Rev. Lett. 1986, 34 (4)). In this polymerization-induced phase separation method, the non-reactive LCs are mixed with a monomer or prepolymer to form a homogeneous mixture. Initially, the mixture is in the isotropic phase as the presence of a relatively large amount of non-LC species disrupts the LC ordering. As the polymerization proceeds, polymer chains adopting random coil conformations form, and the non-reactive LC and non-LC polymer phases separate from each other resulting in a PDLC with a continuous non-LC polymer matrix (with individual chains adopting random coil conformations) and dispersed LC-rich domains (in the LC phase rather than the isotropic phase), as shown in FIG. 3B. The obtained PDLC films are opaque because the oriented domains of LCs confined within the polymer matrix are randomly oriented with respect to each other causing them to scatter light. However, an applied electric field can unidirectionally align all of the LC molecules which increases the transparency of the PDLC. As such, PDLCs have been widely used as electrically switchable materials like smart windows and displays.

### REFERENCES

1. Lendlein, A.; Gould, O. E. C. Reprogrammable Recovery and Actuation Behaviour of Shape-Memory Polymers. Nat. Rev. Mater. 2019, 4, 116.
2. Apsite, I.; Salehi, S.; Ionov, L. Materials for Smart Soft Actuator Systems. Chem. Rev. 2022, 122, 1349.
3. Delaey, J.; Dubruel, P.; Vlierberghe, S. V. Shape-Memory Polymers for Biomedical Applications. Adv. Funct. Mater. 2020, 30, 1909047.
4. Basak, S.; Bandyopadhyay, A. Two-Way Semicrystalline Shape Memory Elastomers: Development and Current Research Trends. Adv. Eng. Mater. 2022, 24, 2200257.
5. Li, S.; Lerch, M. M.; Waters, J. T.; Deng, B.; Martens, R. S.; Yao, Y.; Kim, D.; Bertoldi, K.; Grinthal, A.; Balazes, A.; Aizenberg, J. Self-Regulated Non-Reciprocal Motions in Single-Material Microstructures. Nature 2022, 605, 76.
6. Kotikian, A.; Truby, R. L.; Boley, J. W.; White, T. J.; Lewis, J. A. 3D Printing of Liquid Crystal Elastomeric Actuators with Spatially Programed Nematic Order. Adv. Mater. 2018, 30, 1706164.
7. de Gennes, P. G.; Prost, J. The Physics of Liquid Crystals. Oxford, 1993.
8. White, T.; Broer, D. Programmable and Adaptive Mechanics with Liquid Crystal Polymer Networks and Elastomers. Nat. Mater. 2015, 14, 1087.
9. Xu, Y.; Dupont, R. L.; Yao, Y.; Zhang, M.; Fang, J.-C.; Wang, X. Random Liquid Crystalline Copolymers Consisting of Prolate and Oblate Liquid Crystal Monomers. Macromolecules 2021, 54, 5376.
10. Rahimi, A.; Garcia, J. M. Chemical Recycling of Waste Plastics for New Materials Production. Nat. Rev. Chem. 2017, 1, 0046.

1. A conformationally switching polymer, the polymer comprising:
a monomer and crosslinker, wherein the monomer and crosslinker are component parts of a related non-crystalline polymer, and wherein the monomer and crosslinker are polymerized in a liquid crystal solvent.

2. The polymer of claim 1, wherein the liquid crystal solvent is in a nematic phase.

3. The polymer of claim 1, wherein polymerization is carried out at a temperature at which the liquid crystal solvent is in a nematic phase.

4. The polymer of claim 1, wherein the monomer is chosen from vinyl, acrylate, methacrylate, epoxy, polyester, polyurethane, silicone, and nitrile based of monomers.

5. The polymer of claim 4, wherein the monomer comprises methyl methacrylate, styrene, n-butyl acrylate, t-butyl acrylate, methyl acrylate, or 2-ethylhexyl acrylate.

6. The polymer of claim 1, wherein polymerization comprises photopolymerization.

7. The polymer of claim 1, wherein an external stimulus reversibly changes the polymer's conformation.

8. The polymer of claim 7, wherein the external stimulus is a temperature change, wherein the temperature change is below a glass transition temperature of the polymer.

9. The polymer of claim 1, wherein the polymer is contained in a vessel, and wherein the vessel comprises one or more substrates.

10. The polymer of claim 9, wherein the one or more substrates comprise a chemical coating.

11. The polymer of claim 9, wherein the vessel comprises two substrates having the same or different chemical coatings.

12. The polymer of claim 10, wherein the chemical coatings are ordered to induce liquid crystal alignment.

13. The polymer of claim 1, wherein the liquid crystal solvent is removed after the polymer is formed.

14. The polymer of claim 13, wherein the polymer retains conformational switching after the liquid crystal solvent is removed.

15. The polymer of claim 13, wherein a solvent is used to remove the liquid crystal solvent.

16. A method of forming a conformationally switching polymer, the method comprising:
providing a liquid crystal solvent;
providing a monomer and a crosslinker into the liquid crystal solvent, wherein the monomer and the crosslinker are non-crystalline; and
polymerizing the monomer and the crosslinker in the liquid crystal solvent at a temperature at which the liquid crystal solvent is in a nematic phase.

17. (canceled)

18. (canceled)

19. (canceled)

20. (canceled)

21. (canceled)

22. (canceled)

23. The method of claim 16, wherein a first external stimulus is provided for polymerizing.

24. The method of claim 23, wherein the first external stimulus is light radiation.

25. The method of claim 24, comprising providing a second external stimulus to the polymer, wherein the second external stimulus changes the polymer's conformation.

26. The method of claim 25, wherein the second external stimulus is a temperature change.

27. (canceled)

28. (canceled)

29. (canceled)

30. (canceled)
